(19) United States
(12) Patent Application Publication
(10) Pub. No.: US 2026/0259400 A1
(43) Pub. Date: Sep. 3, 2026

(54) RITCHEY-CHRÉTIEN TELESCOPE SYSTEM WITH A MULTI-LENS CORRECTOR

(71) Applicant: Youngwan Choi, Los Angeles, CA (US)

(72) Inventor: Youngwan Choi, Los Angeles, CA (US)

(21) Appl. No.: 19/554,255

(22) Filed: Mar. 2, 2026

Related U.S. Application Data
(60) Provisional application No. 63/766,142, filed on Mar. 3, 2025.

(51) Int. Cl. G02B 23/06; G02B 27/00

(52) U.S. Cl. CPC G02B 23/06; G02B 27/0068

(57) ABSTRACT

A Ritchey-Chrétien (RC) telescope system includes an RC telescope. The RC telescope includes a primary mirror having a diameter, a secondary mirror aligned with the primary mirror along an optical axis, wherein a distance between the primary mirror and the secondary mirror along the optical axis is defined as a mirror distance, and a corrector assembly comprising a plurality of lens elements. The corrector assembly is positioned with respect to the primary mirror and the secondary mirror such that the mirror distance is maintained at less than or equal to 1.5 times the diameter of the primary mirror.

### INCORPORATION BY REFERENCE TO ANY PRIORITY APPLICATIONS

This application claims benefit of U.S. Provisional Application No. 63/766,142, filed Mar. 3, 2025, entitled “TELECENTRIC RITCHEY-CHRÉTIEN TELESCOPE FOR LOW-ALTITUDE EARTH OBSERVATION WITH A MULTI-LENS TELECENTRIC CORRECTOR”, the content of which is incorporated herein by reference in its entirety.

### BACKGROUND

### Field

This disclosure relates generally to optical devices, optical imaging systems, and methods for space-based imaging. More particularly, the disclosure relates to telescope architectures, reflective optical systems, and imaging methods configured for high-resolution imaging applications, including satellite-based and aerial imaging applications.

### Description of Related Technology

Optical imaging systems are widely used in a variety of applications, including space-based Earth observation, remote sensing, and other high-resolution imaging environments. Many imaging systems employ reflective telescope architectures, including variations of Cassegrain, Gregorian, and Ritchey-Chrétien (RC) configurations. These systems typically utilize one or more mirrors to collect, fold, and focus incoming radiation while reducing optical aberrations such as coma, spherical aberration, and astigmatism. Traditional RC telescope architectures can provide relatively wide, well-corrected fields of view within compact packaging constraints.

### SUMMARY

The embodiments disclosed herein each have several aspects, no single one of which is solely responsible for the disclosure's desirable attributes. Without limiting the scope of this disclosure, its more prominent features will now be briefly discussed. After considering this discussion, and particularly after reading the section entitled “Detailed Description,” one will understand how the features of the embodiments described herein provide advantages over existing optical systems, devices, and methods.

In one aspect, a Ritchey-Chrétien (RC) telescope system includes an RC telescope. The RC telescope includes a primary mirror having a diameter, a secondary mirror aligned with the primary mirror along an optical axis extending from a vertex of the primary mirror to a vertex of the secondary mirror, wherein a distance between the primary mirror and the secondary mirror along the optical axis is defined as a mirror distance, and a corrector assembly comprising a plurality of lens elements, the corrector assembly being positioned with respect to the primary mirror and the secondary mirror such that the mirror distance is maintained at less than or equal to 1.5 times the diameter of the primary mirror.

In some embodiments, the corrector assembly is positioned with respect to the primary mirror and the secondary mirror such that the mirror distance is maintained at less than or equal to 1.2 times the diameter of the primary mirror.

In some embodiments, the corrector assembly is positioned such that a telecentricity of the Ritchey-Chrétien telescope system maintains substantially constant.

In some embodiments, the Ritchey-Chrétien (RC) telescope system further includes an image plane positioned to receive light transmitted through the corrector assembly after being reflected from the primary mirror and reflected from the secondary mirror.

In some embodiments, the lens elements of the corrector assembly are arranged such that chief rays are substantially parallel to the optical axis at the image plane.

In some embodiments, the corrector assembly comprises at least six lens elements.

In some embodiments, all of the plurality of lens elements of the corrector assembly are positioned along the optical axis between the primary mirror and the secondary mirrors.

In some embodiments, at least one of the plurality of lens elements of the corrector assembly is not positioned along the optical axis.

In some embodiments, the Ritchey-Chrétien (RC) telescope system further includes a tertiary mirror.

In some embodiments, the tertiary mirror is aligned with the secondary mirror along a secondary optical axis extending from the vertex of the secondary mirror to a vertex of the tertiary mirror.

In some embodiments, all of the lens elements of the corrector assembly are positioned outside an outer diameter of the primary mirror.

In some embodiments, all of the lens elements are aligned along the optical axis.

In some embodiments, the corrector assembly comprises a first end and a second end opposing each other, and wherein the mirror distance is greater than a distance between the vertex of the primary mirror and the first end of the corrector assembly, and wherein the first end is closer to the primary mirror than the second end.

In some embodiments, a first subset of the lens elements of the corrector assembly is positioned between the primary mirror, and a second subset of the lens elements is positioned outside an outer diameter of the primary mirror.

In some embodiments, the first subset and the second subset are aligned along the optical axis.

In some embodiments, the primary mirror has a focal length adjustable according to a position of the corrector assembly with respect to the primary mirror and the secondary mirror.

In some embodiments, the telecentricity is maintained by adjusting radii of curvature of the plurality of lens elements of the corrector assembly.

In some embodiments, the telecentricity is maintained by adjusting axial spacing between the plurality of lens elements of the corrector assembly.

In some embodiments, the Ritchey-Chrétien (RC) telescope system further includes comprising one or more sensors operatively coupled to the RC telescope and configured to receive light at the image plane and generate image signals representative of the received light.

In another aspect, a satellite includes the Ritchey-Chrétien telescope system as described above.

Any of the features of an aspect is applicable to all aspects identified herein. Moreover, any of the features of an aspect is independently combinable, partly or wholly with other aspects described herein in any way, e.g., one, two, or three or more aspects may be combinable in whole or in part. Further, any of the features of an aspect may be made optional to other aspects. Any aspect of a method can comprise another aspect of a system. Furthermore, any aspect of a system can be configured to perform a method of another aspect. Furthermore, any aspect of a method can comprise another aspect of a system. Moreover, any aspect of a system can be configured to perform a method of another aspect.

### BRIEF DESCRIPTION OF THE DRAWINGS

Elements in the figures have not necessarily been drawn to scale in order to enhance their clarity and improve understanding of these various elements and embodiments described herein. Furthermore, elements that are known to be common and well understood to those in the industry are not depicted in order to provide a clear view of the various embodiments described herein, thus the drawings are generalized in form in the interest of clarity and conciseness.

FIG. 1 is a schematic illustration of an example Ritchey-Chrétien telescope system that may be used for space-based imaging.

FIG. 2A is a schematic illustration showing an embodiment of a Ritchey-Chrétien telescope system that may be used for space-based imaging.

FIG. 2B illustrates an example chief-ray angle versus field position at image planes according to the FIG. 2A embodiment.

FIG. 2C illustrates an example field distortion map of the FIG. 2A embodiment.

FIG. 3A is a schematic illustration showing another embodiment of a Ritchey-Chrétien telescope system that may be used for space-based imaging.

FIG. 3B illustrates an example chief-ray angle versus field position at image planes according to the FIG. 3A embodiment.

FIG. 3C illustrates an example field distortion map of the FIG. 3A embodiment.

FIG. 4A is a schematic illustration showing another embodiment of a Ritchey-Chrétien telescope system that may be used for space-based imaging.

FIG. 4B illustrates an example chief-ray angle versus field position at image planes according to the FIG. 4A embodiment.

FIG. 4C illustrates an example field distortion map of the FIG. 4A embodiment.

FIG. 5A is a schematic illustration showing another embodiment of a Ritchey-Chrétien telescope system that may be used for space-based imaging.

FIG. 5B illustrates an example chief-ray angle versus field position at image planes according to the FIG. 5A embodiment.

FIG. 5C illustrates an example field distortion map of the FIG. 5A embodiment.

FIG. 6A is a schematic illustration showing another embodiment of a Ritchey-Chrétien telescope system that may be used for space-based imaging.

FIG. 6B illustrates an example chief-ray angle versus field position at image planes according to the FIG. 6A embodiment.

FIG. 6C illustrates an example field distortion map of the FIG. 6A embodiment.

FIG. 7A is a schematic illustration showing another embodiment of a Ritchey-Chrétien telescope system that may be used for space-based imaging.

FIG. 7B illustrates an example chief-ray angle versus field position at image planes according to the FIG. 7A embodiment.

FIG. 7C illustrates an example field distortion map of the FIG. 7A embodiment.

FIG. 8A is a schematic illustration showing another embodiment of a Ritchey-Chrétien telescope system that may be used for space-based imaging.

FIG. 8B illustrates an example chief-ray angle versus field position at image planes according to the FIG. 8A embodiment.

FIG. 8C illustrates an example field distortion map of the FIG. 8A embodiment.

FIG. 9A is a schematic illustration showing another embodiment of a Ritchey-Chrétien telescope system that may be used for space-based imaging.

FIG. 9B illustrates an example chief-ray angle versus field position at image planes according to the FIG. 9A embodiment.

FIG. 9C illustrates an example field distortion map of the FIG. 9A embodiment.

FIG. 10A is a schematic illustration showing another embodiment of a Ritchey-Chrétien telescope system that may be used for space-based imaging.

FIG. 10B illustrates an example chief-ray angle versus field position at image planes according to the FIG. 10A embodiment.

FIG. 10C illustrates an example field distortion map of the FIG. 10A embodiment.

FIG. 11A is a schematic illustration showing another embodiment of a Ritchey-Chrétien telescope system that may be used for space-based imaging.

FIG. 11B illustrates an example chief-ray angle versus field position at image planes according to the FIG. 11A embodiment.

FIG. 11C illustrates an example field distortion map of the FIG. 11A embodiment.

FIG. 12A is a schematic illustration showing another embodiment of a Ritchey-Chrétien telescope system that may be used for space-based imaging.

FIG. 12B illustrates an example chief-ray angle versus field position at image planes according to the FIG. 12A embodiment.

FIG. 12C illustrates an example field distortion map of the FIG. 12A embodiment.

FIG. 13A is a schematic illustration showing another embodiment of a Ritchey-Chrétien telescope system that may be used for space-based imaging.

FIG. 13B illustrates an example chief-ray angle versus field position at image planes according to the FIG. 13A embodiment.

FIG. 13C illustrates an example field distortion map of the FIG. 13A embodiment.

FIG. 14A is a schematic illustration showing another embodiment of a Ritchey-Chrétien telescope system that may be used for space-based imaging.

FIG. 14B illustrates an example chief-ray angle versus field position at image planes according to the FIG. 14A embodiment.

FIG. 14C illustrates an example field distortion map of the FIG. 14A embodiment.

FIG. 15A is a schematic illustration showing another embodiment of a Ritchey-Chrétien telescope system that may be used for space-based imaging.

FIG. 15B illustrates an example chief-ray angle versus field position at image planes according to the FIG. 15A embodiment.

FIG. 15C illustrates an example field distortion map of the FIG. 15A embodiment.

FIG. 16A is a schematic illustration showing another embodiment of a Ritchey-Chrétien telescope system that may be used for space-based imaging.

FIG. 16B illustrates an example chief-ray angle versus field position at image planes according to the FIG. 16A embodiment.

FIG. 16C illustrates an example field distortion map of the FIG. 16A embodiment.

FIG. 17A is a schematic illustration showing another embodiment of a Ritchey-Chrétien telescope system that may be used for space-based imaging.

FIG. 17B illustrates an example chief-ray angle versus field position at image planes according to the FIG. 17A embodiment.

FIG. 17C illustrates an example field distortion map of the FIG. 17A embodiment.

FIG. 18A is a schematic illustration showing another embodiment of a Ritchey-Chrétien telescope system that may be used for space-based imaging.

FIG. 18B illustrates an example chief-ray angle versus field position at image planes according to the FIG. 18A embodiment.

FIG. 18C illustrates an example field distortion map of the FIG. 18A embodiment.

FIG. 19A is a schematic illustration showing another embodiment of a Ritchey-Chrétien telescope system that may be used for space-based imaging.

FIG. 19B illustrates an example chief-ray angle versus field position at image planes according to the FIG. 19A embodiment.

FIG. 19C illustrates an example field distortion map of the FIG. 19A embodiment.

### DETAILED DESCRIPTION

While RC designs can correct many on-axis and near-axis aberrations, they do not inherently provide telecentricity in image space, which is often important for consistent radiometry, band-to-band co-registration, and minimal distortion in modern remote sensing. In non-telecentric systems, chief rays corresponding to off-axis field points may intersect the image plane at oblique angles.

Non-telecentric imaging can introduce geometric distortion, non-uniform illumination, and variation in effective pixel scale across the focal plane. Such effects may be particularly relevant in multi-spectral and hyperspectral imaging applications, where different spectral channels ideally observe a scene under substantially similar geometric conditions. Variations in chief ray angle across the field can complicate band-to-band co-registration and may reduce the accuracy of derived analytical products.

To mitigate residual aberrations and field curvature, existing wide-field systems often incorporate refractive field-correcting elements, e.g., groups of lens elements, to address residual off-axis aberrations and flatten the focal plane. While such correctors can improve imaging performance, they do not necessarily impose image-space telecentricity and may increase system complexity, mass, and alignment sensitivity. For example, non-telecentric image formation can lead to perspective distortions, non-uniform illumination, and pixel-scale variations in multi-spectral and hyperspectral imaging scenarios, where each band (or channel) ideally observes the scene under identical geometric conditions. Such variations complicate the alignment of narrow spectral bands, potentially degrading the quality of derived indices like Normalized Difference Vegetation Index (NDVI) or water chemistry parameters.

The increasing adoption of time-delay integration (TDI) sensors in line-scanning (pushbroom) imagers has further emphasized the importance of consistent projection geometry across the focal plane. TDI sensors accumulate charge across successive exposures as a scene moves relative to the detector array, thereby improving signal-to-noise ratio. However, effective TDI operation typically relies on substantially uniform chief ray angles and low distortion across the image plane. Variations in angle of incidence across the field may lead to image smear, banding artifacts, or reduced effective resolution. Therefore, there remains a need for improved optical devices and optical imaging systems for space-based imaging.

In the following discussion that addresses a number of embodiments and applications, reference is made to the accompanying drawings that form a part hereof, and in which is shown by way of illustration specific embodiments in which the embodiments described herein may be practiced. It is to be understood that other embodiments may be utilized, and changes may be made without departing from the scope of the disclosure.

Various inventive features are described below that can each be used independently of one another or in combination with another feature or features. However, any single inventive feature may not address all of the problems discussed above or only address one of the problems discussed above. Further, one or more of the problems discussed above may not be fully addressed by the features of each embodiment described below.

Described herein are embodiments of telecentric, high resolution optical imaging systems, e.g., Ritchey-Chrétien (RC) telescope systems and methods that can be used in space-based and aerial imaging applications, for example, low-altitude Earth observation. In some implementations, the disclosed systems may include multi-spectral, hyperspectral, and time-delay integration (TDI) imaging in low Earth orbit (LEO) or other orbital regimes. As used herein, the term “telecentric” refers to an optical configuration in which chief rays are substantially parallel to the optical axis in image space, such that light reaches the image plane at or near normal incidence across the field of view. As used herein, the term “effective focal length (EFL)” has its usual and customary meaning and includes without limitation the distance from a principal plane of an optical mirror to an image plane. As used herein, the “clear aperture (CLA)” refers to the useable optical opening allowing the rays to pass without being blocked. As used herein, the “overall axial length (OAL)” refers to an axial optical length measured along the optical axis between a vertex of the primary mirror and the image plane. As used herein, the “LEN” refers to a total length of the optical system. As used herein, the “chief rays” refers to a ray originating from a specific object field point that passes through a center of an entrance pupil of the optical system and propagates to the image plane.

An optical system, e.g., an RC telescope system or a Cassegrain telescope system may be used for providing telecentric and high-resolution imaging performance for earth observation.

In some embodiments, the optical system may include a reflective telescope architecture based on an RC design having hyperbolic primary and secondary mirrors, together with a compact multi-lens corrector assembly and an image plane. The multi-lens corrector assembly may be configured to provide image-space telecentricity by arranging the optical elements such that chief rays can reach a detector at substantially uniform angles of incidence across the image plane, e.g., focal plane.

The disclosed systems and methods may provide substantial benefits over existing optics based sensing systems such as satellite-based remote sensing applications where consistent projection geometry is desirable. For example, in TDI line-scanning (pushbroom) imagers, charge accumulation across successive passes of a scene over the same detector elements may benefit from near-uniform chief ray angles and low distortion across the image plane. By providing image-space telecentricity, disclosed systems and methods may mitigate one or more of image smear, banding artifacts, or resolution degradation that can arise from field-dependent angle variations. The disclosed systems and methods can be advantageous for multi-spectral, hyperspectral, and time-delay integration (TDI) imaging in low earth orbit (LEO) and similar orbital regimes. The disclosed systems and methods may also address the longstanding challenges in satellite-based remote sensing.

In some embodiments, the optical system may be configured to achieve sub-10-meter ground sample distances (GSD) while covering relatively large swaths from orbital altitudes that may be below approximately 500 kilometers. Reflective folding of the optical path in an RC configuration can provide a comparatively long effective focal length within a compact envelope, thereby addressing limitations of traditional telescopes in mass-and volume-constrained environments. The multi-element corrector may preserve the benefits of the reflective architecture while enabling telecentric performance across an extended field of view.

Unlike existing RC telescope designs, which are not inherently telecentric in image space, the disclosed systems and methods employ an optimized corrector assembly to achieve substantially telecentric chief ray behavior at the detector. This telecentric characteristic may support improved geometric consistency across spectral bands and detector rows, which can be beneficial for precision Earth-monitoring and analytical imaging applications.

### Optical Imaging Systems

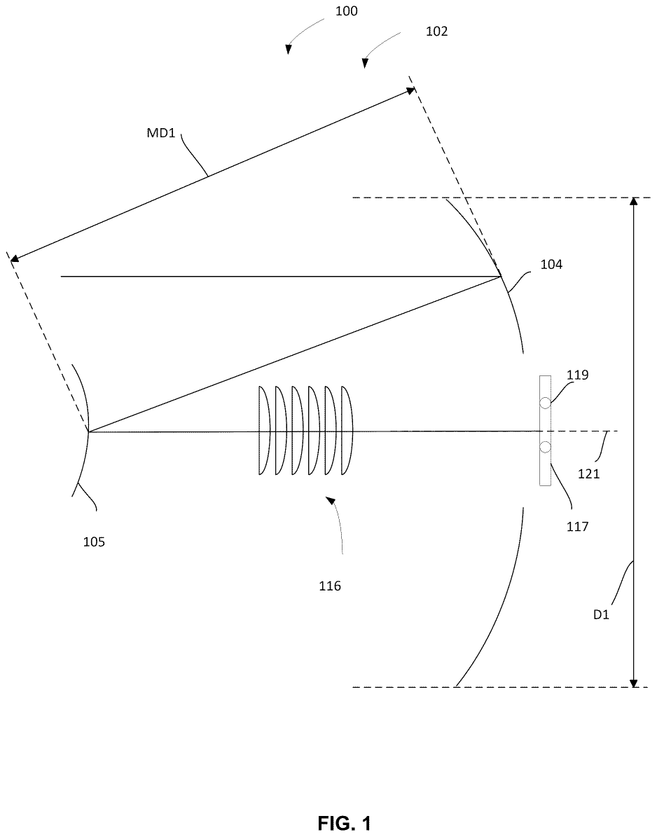

FIG. 1 is a schematic illustration of an example RC telescope system 100 that may be used for space-based imaging.

In some embodiments, the RC telescope system 100 may include an RC telescope 102. The RC telescope 102 may include a primary mirror 104 having a diameter D1, a secondary mirror 105, and a corrector assembly 116.

In some embodiments, the primary mirror 104 may be a concave mirror having a hyperbolic surface profile and a central aperture. The primary mirror 104 may have a parabolic surface, a non-parabolic conical surface, or an aspherical surface. A “parabolic surface” as used herein has its usual and customary meaning, and includes, without limitation, a reflective surface used to collect the light energy and may have a shape that is part of a circular paraboloid, that is, the surface generated by a parabola revolving around its axis. A “non-parabolic conical surface” as used herein has its usual and customary meaning, and includes, without limitation, a curve rotated about its axis where the curve is obtained as the intersection of the surface of a cone with a plane other than a parabola. For example, the “non-parabolic conical surface” may be hyperbolic, elliptical, or circular. An “aspherical surface” as used herein has its usual and customary meaning, and includes, without limitation, a surface that is not spherical. In some embodiments, a spherical surface may be slightly altered so as to reduce spherical aberration.

In some embodiments, the secondary mirror 105 may be aligned with the primary mirror 104 along an optical axis 121. As used herein, the term “optical axis” refers to a reference axis extending from a vertex of the primary mirror 104 to a vertex of the secondary mirror 105 and to an image plane. The distance between the primary mirror 104 and the secondary mirror 105 along the optical axis 121 is defined as a mirror distance MD1. The diameter of the primary mirror D1 is measured across the reflective surface of the primary mirror 104.

The corrector assembly 116 may include a plurality of lens elements. The corrector assembly 116 may be positioned with respect to the primary mirror 104 and the secondary mirror 105 such that light reflected by the secondary mirror 105 is provided to the primary mirror 104 via the corrector assembly 116. In some embodiments, the correctors assembly 116 may be positioned proximate to the primary mirror vertex region, including locations before or after the primary mirror 104 along the optical axis 121. For example, the correctors assembly 116 is disposed along the optical path between the primary mirror 104 and the image plane 117, proximate to the focal plane assembly. The associated lens cell may include thermal compensation structures to maintain predetermined inter-element spacing tolerances across temperature variations. In some embodiments, telecentricity may be controlled by adjusting radii of curvature and axial spacing between lens elements, without requiring changes in lens material composition.

In some embodiments, the corrector assembly 116 may include at least 6 lens elements, for example, at least 6, 7, 8, 9, 10, 11, or 12, 13, 14, 15, 16, 17, 18, 19, or 20, or more lens elements. In some embodiments, the lens elements may be arranged to reduce residual aberrations, including field curvature and off-axis aberrations, and to control projection geometry at an image plane 117. The lenses may have spherical or aspherical surfaces configured for aft-optics correction. Based on the system parameters, e.g., effective focal length and clear aperture, the corrector lens arrangement may be selected according to various design considerations, e.g., lens selection, number of lenses, lens orientation, oblique angle, and additional parameters to achieve specific imaging characteristics. These lens elements may have various geometrical, optical, and surface characteristics, e.g., lens type, radius of curvature, clear aperture, diameter, dimensions, shape, materials, surface flatness, surface roughness, reflectivity, wavelength range, angle of incidence, and additional specifications, or any combination thereof. In some embodiments, the lens elements of the corrector assembly 116 may be formed from three distinct optical materials selected to provide dispersion balancing and broadband transmission. Example materials may include BK7 or another crown glass suitable for visible wavelengths, fused silica, and calcium fluoride (CaF₂). BK7 is a crown glass exhibiting moderate dispersion and high optical clarity for visible wavelengths. Fused silica can provide low thermal expansion and extended transmission from ultraviolet through near-infrared wavelengths. CaF₂ can provide relatively low dispersion suitable for chromatic correction in near-infrared and/or short-wave infrared bands. By forming the lens elements from materials having different refractive indices and Abbe numbers, the corrector assembly 116 may reduce chromatic aberrations across multiple wavebands.

The materials may be selected in accordance with system design parameters and specific optical performance, including, e.g., an imaging spectrum range, a distance between the primary mirror and the secondary mirror, a distance between the secondary mirror and the image plane, allowable residual optical error or aberration, allowable distortion, telecentricity requirements, wavefront error limits, and modulation transfer function. Lens surfaces may have different shapes, e.g., spherical, aspherical and free-form surfaces, selected to achieve specific aberration correction requirements. The corrector assembly 116 may be a telecentric corrector assembly. The assembly 116 may be positioned proximate to the image plane 117 such that residual off-axis aberrations are reduced and the focal surface is flattened.

As shown in FIG. 1, the corrector assembly 116 may include lens elements with different shapes, surface profiles, and/or orientations. Within the corrector assembly 116, the rays may pass through multiple lenses with incremental corrective adjustments applied at successive optical surfaces until reaching the image plane 117. In certain embodiments, the corrector assembly 116 may include more than six groups of lenses disposed between the secondary mirror 105 and the image plane 117. The rays may initially converge after passing through a first lens group and may subsequently be redirected by one or more intermediate lens elements before reaching the image plane 117. A final lens group may direct the radiation toward and onto the image plane 117. Advantageously, a corrector assembly may reduce mass, air-glass interfaces, ghost reflections, and alignment sensitivity.

The corrector assembly 116 may be arranged to produce an image-space telecentric output. The lens arrangement may be configured such that chief rays across the image field remain substantially parallel to the optical axis at the image plane 117, thereby forming a telecentric exit pupil. In some embodiments, the optical elements are arranged such that the exit pupil is positioned to achieve image-space telecentricity at the image plane 117. As a result, chief rays across the field of view may be substantially perpendicular to the image plane 117. This configuration may reduce perspective distortion and maintain a substantially constant angular subtense per pixel or per line detector element, regardless of off-axis field position. The corrector assembly 116 may further include one or more monolithic lens barrels, thermally compensated spacers, precision axial shimming features, radial centering sleeves, and vibration-isolated mounting interfaces.

In some embodiments, the corrector assembly 116 may be positioned with respect to the primary mirror 104 and the secondary mirror 105 such that the mirror distance MD1 is maintained less than or equal to 1.5 times or about 1.5 times the diameter D1 of the primary mirror. For example, the mirror distance MD1 may be less than or equal to about 1.4 times D1, less than or equal to about 1.3 times D1, less than or equal to about 1.2 times D1, less than or equal to about 1.1 times D1, less than or equal to about 1.0 times D1, less than or equal to about 0.9 times D1, less than or equal to about 0.8 times D1, less than or equal to about 0.7 times D1, less than or equal to about 0.6 times D1, less than or equal to about 0.5 times D1, less than or equal to about 0.25 times D1, a value in a range defined by any of these values, or any value between the above described ranges.

The corrector assembly 116 may be arranged in various configurations and may be positioned at different locations along or relative to the optical axis 121. In some embodiments, the correct assembly 116 may be positioned along the optical axis 121 between the second mirror 105 and the image plane 117. In certain embodiments, all lens elements of the corrector assembly may be positioned along the optical axis 121 between the primary mirror 104 and the secondary mirror 105. In certain embodiments, the lens elements of corrector assembly 116 may be mounted within the mirror cavity region between the primary mirror 104 and the secondary mirror 105. In these embodiments, the lens elements of corrector assembly 116 may be mechanically integrated via a rigid lens barrel secured to the metering structure. This configuration may form a compact structure. This compact structure may allow insertion without interfering with marginal ray envelopes. In some embodiments, the corrector assembly 116 may be positioned along the optical axis 121 proximate to the image plane 117 between the second mirror 105 and the image plane 117. The lens elements of the corrector assembly 116 may include a thermal compensation structure. The thermal compensation structure can maintain the predetermined space among lens elements across temperature variations. In other embodiments, the corrector assembly 116 may be positioned along the optical path 121 and proximate to the primary mirror 104 vertex region, e.g., before or after the primary mirror 104. In some embodiments, the telecentricity may be maintained by adjusting certain parameters, e.g., radii of curvature and axial spacing among lens elements, without changing the material composition of lens elements.

The image plane 117, e.g., a focal plane, may include one or more focal plane detectors. The detectors may comprise a two-dimensional imaging array, such as a CCD or CMOS sensor, or a line-scanning detector. In some embodiments, the optical system 100 may be configured for earth observation at orbital altitudes below approximately 500 kilometers and may support ground sample distances on the order of 10 meters or better, depending on aperture size, effective focal length, and detector characteristics. The corrector assembly 116 may reduce moment arm relative to the primary mirror, improving launch survivability and alignment stability.

The system 100 may include one or more image planes. The system 100 may further include one or more sensors 119 operatively coupled to the RC telescope 102 and configured to receive light at the image plane and generate image signals representative of the received light. The sensors 119 may be disposed at or proximate to the image plane 117. The sensors may include scientific CMOS, CMOS, CCD, a photodiode with a CMOS readout integrated circuit, a single-photon avalanche diode, a dynamic vision sensor or event-based sensor, an electron-multiplying CCD, or a combination thereof. The sensors may be of an area-array type, a linear type, a multi-linear type, a time-delay-integration (TDI) type, a non-time-delay-integration type, or a combination thereof.

The optical system 100 may further include a metering structure, e.g., a low-thermal-expansion metering structure configured to maintain relative alignment of optical components. The primary mirror 104, secondary mirror 105, and telecentric corrector assembly 116 may be mounted on a rigid, thermally stable bench, such as carbon fiber-reinforced polymer, Zerodur®, or silicon carbide. The metering structure may be configured to maintain optical alignment under launch vibration loads and orbital thermal cycling conditions, thereby preserving system performance.

The optical path lines illustrated in FIG. 1 may represent radiation from different field positions entering the optical system 100. Incoming radiation may first reflect from the primary mirror 104 toward the secondary mirror 105. The secondary mirror 105 may then reflect the radiation toward the primary mirror 104 along a folded optical path. This folded reflective geometry may provide a comparatively long effective focal length while maintaining a compact physical configuration. After reflection from the secondary mirror 105, the radiation may travel toward the corrector assembly 116 and then toward and through a central aperture of the primary mirror 104. The lens elements of the corrector assembly 116 may refract the radiation to reduce residual aberrations and to shape the chief-ray geometry at the image plane 117.

In some embodiments, the corrector assembly 116 may be arranged to provide image-space telecentric behavior. In such configurations, chief rays corresponding to different field positions may be substantially perpendicular to the image plane 117. The corrector assembly 116 may be positioned such that the telecentricity of the RC telescope system 100 maintains substantially constant. Such telecentric behavior may be particularly beneficial in line-scanning (pushbroom) or time-delay-integration (TDI) detectors, where uniform projection geometry across the focal plane may reduce image smear, banding artifacts, and field-dependent pixel footprint variation.

In this disclosure, the RC telescope 102 may have a variety of EFL, CLA, and OAL as long as the RC telescope 102 operates as described above. Thus, specific numbers for EFL, CLA, and OAL disclosed herein are for the purpose of convenience od description and can be modified without departing from inventive concepts.

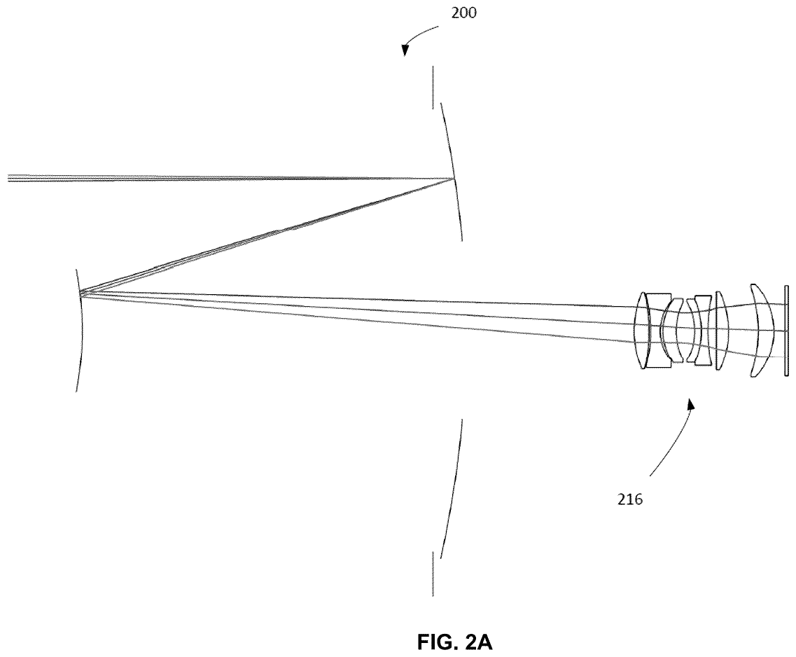

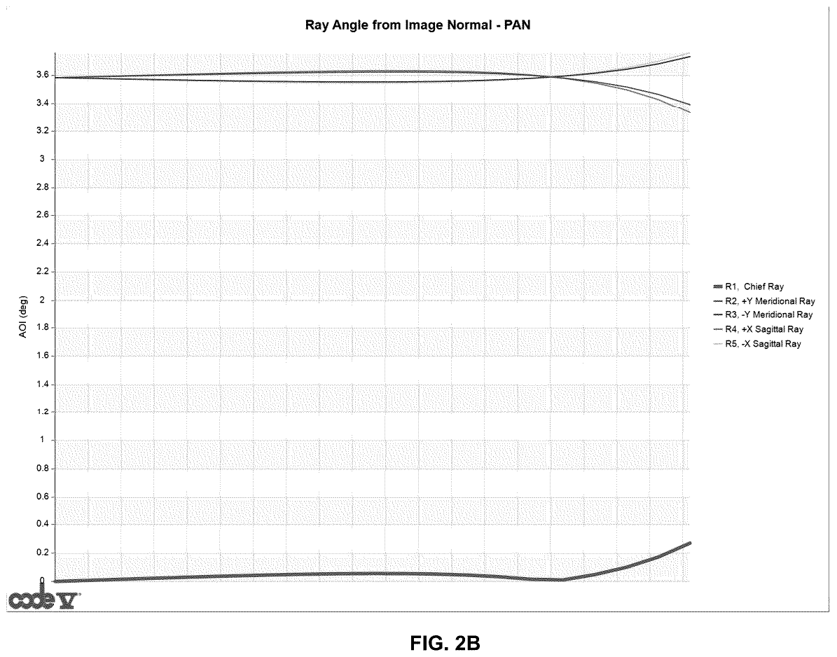

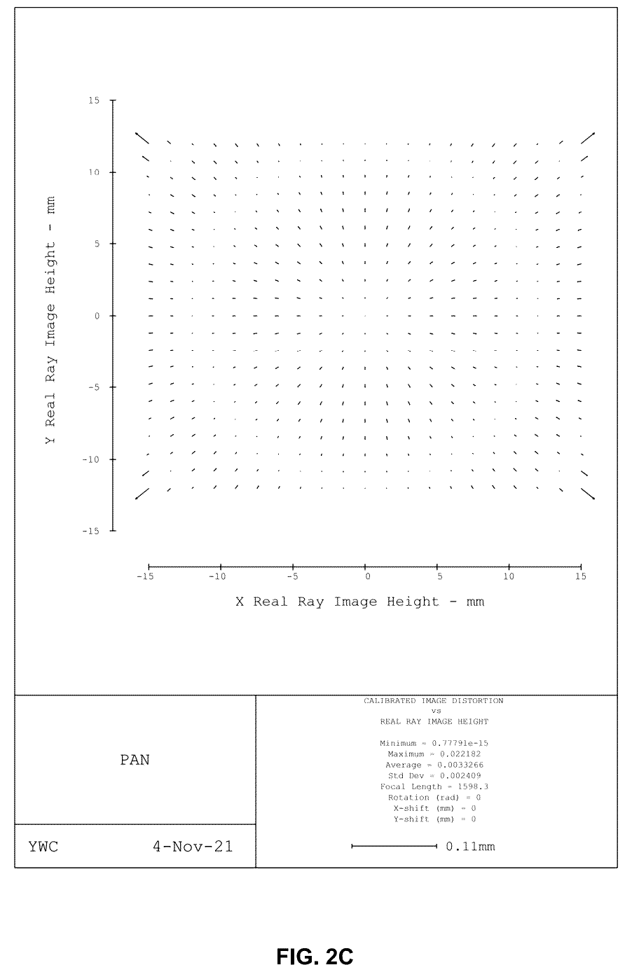

FIG. 2A is a schematic illustration showing an embodiment of a Ritchey-Chrétien telescope system 200 that may be used for space-based imaging. FIG. 2B illustrates an example chief-ray angle versus field position at image planes according to the FIG. 2A embodiment. FIG. 2C illustrates an example field distortion map of the FIG. 2A embodiment.

In certain embodiments, the RC telescope system 200 may have an EFL of about 1600 mm and a CLA of about 200 mm. Unless otherwise indicated, the embodiment illustrated in FIG. 2A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

As shown in FIG. 2A, the corrector assembly 216 may include at least 6 lens elements, for example, at least 6, 7, 8, 9, 10, 11, or 12, 13, 14, 15, 16, 17, 18, 19, or 20, or more lens elements. In certain embodiments, the corrector assembly 216 may be positioned along the optical axis between the secondary mirror and the image plane. All of the lens elements of the corrector assembly 216 may be positioned outside an outer diameter of the primary mirror. Image-space telecentricity may be achieved by adjusting optical parameters, e.g., surface curvature and axial spacing among the lens elements. The rays may be controlled to converge through the corrector assembly 216 and direct to the image plane to form the final image. The rays may be parallel to the optical axis at the image plane, thereby demonstrating telecentricity. The mirror distance MD1 may have a variety of numbers as described with respect to FIG. 1. This configuration can maintain imaging performance, e.g., controlled distortion and telecentric performance, allowing the compact structure suitable for a platform, e.g., a small-satellite or CubeSat.

Referring to FIG. 2B, the chief-ray angle versus field position demonstrates the image-space telecentricity at the image plane according to some embodiments of the RC telescope system in FIG. 2A. As shown in FIG. 2B, the rays are substantially parallel to the optical axis at the image plane, which demonstrates telecentricity. In various embodiments, the chief-ray angle (CRA) at the image plane may be equal or less than about 5 degrees, 3 degrees, 2 degrees, 1.5 degrees, or 1 degree, or any number therebetween. The CRA may be maintained below a specified value across, e.g., at least about 50%, at least about 60%, at least about 70%, at least about 80%, at least about than 90% of the usable field of view, or any number therebetween. In certain embodiments, the ray angle as a function of field position corresponds to an optical configuration having an EFL of about 1600 mm and a CLA of about 200 mm.

FIG. 2B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 2B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 2C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 2C, the map illustrates near-zero geometric distortion across the usable field of view according to some embodiments of the RC telescope system illustrated in FIG. 2A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.022, the average distortion is approximately 0.0033, and the standard deviation is approximately 0.0024. FIG. 2C shows that, advantageously, the configuration of the RC telescope system achieves reduced geometric distortion across the usable field of view while maintaining image-space telecentricity.

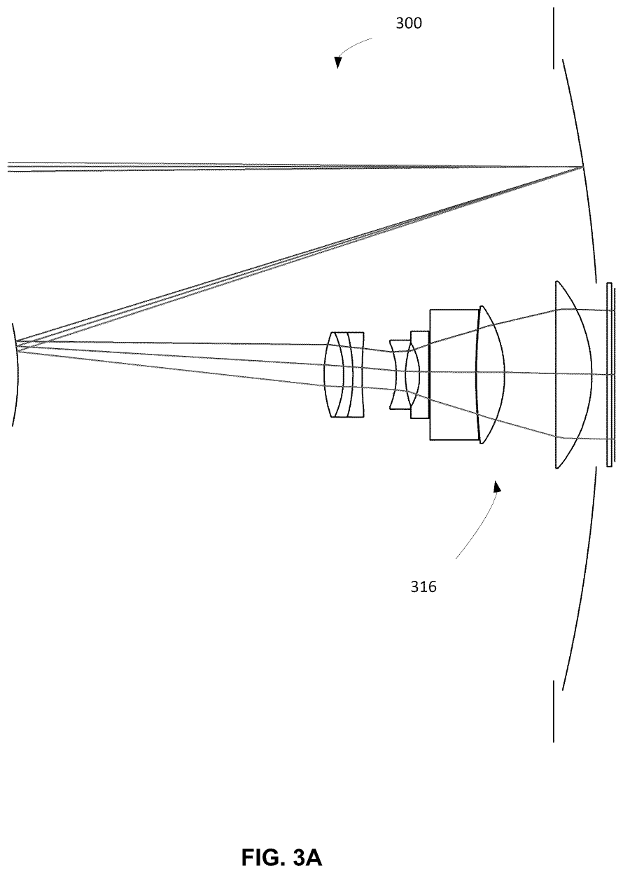

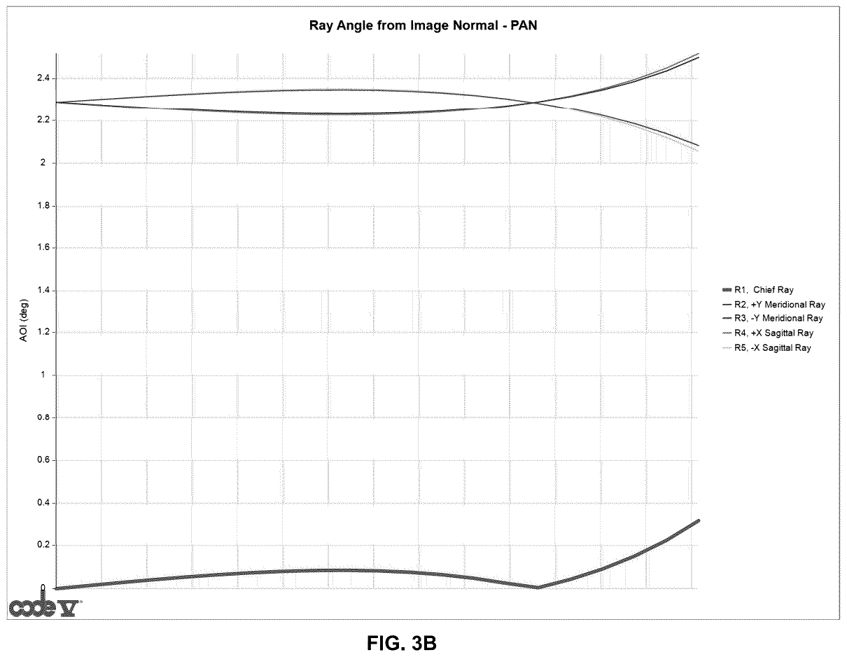

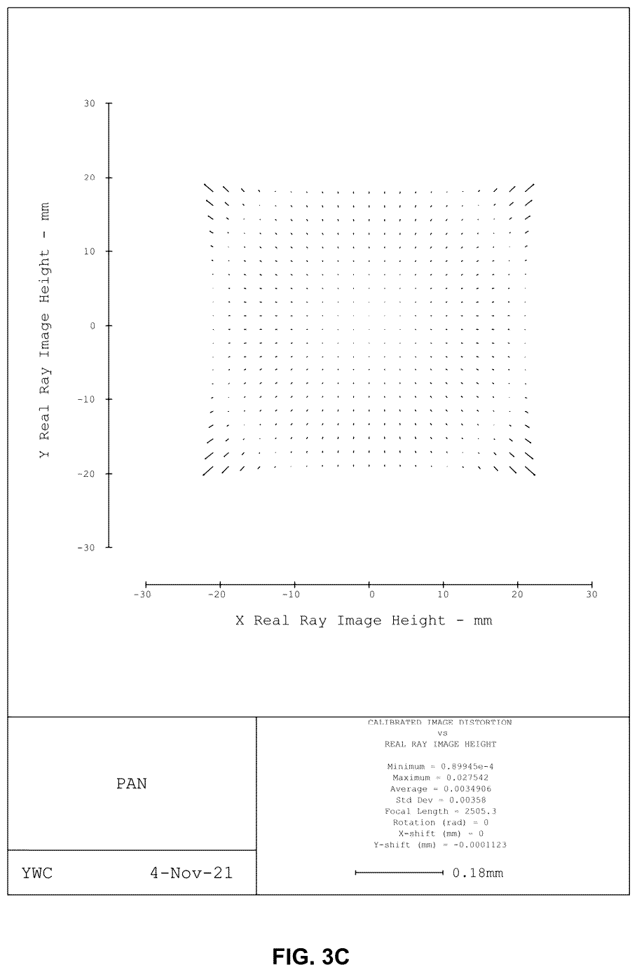

FIG. 3A is a schematic illustration showing another embodiment of a Ritchey-Chrétien telescope system 300 that may be used for space-based imaging. FIG. 3B illustrates an example chief-ray angle versus field position at image planes according to the FIG. 3A embodiment. FIG. 3C illustrates an example field distortion map of the FIG. 3A embodiment.

Referring to FIG. 3A, a schematic of an embodiment of a RC telescope system 300 is shown. In certain embodiments, the RC telescope system 300 may have an EFL of about 2500 mm and a CLA of about 200 mm. Unless otherwise indicated, the embodiments illustrated in FIG. 3A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

In certain embodiments, the corrector assembly 316 may be positioned along the optical axis between the primary mirror and the secondary mirror. All of the lens elements of the corrector assembly 316 may be positioned inside the outer diameter of the primary mirror and at least one of the lens elements is positioned closer to the primary mirror than the remaining lens elements. For example, as shown in FIG. 3A, the corrector assembly 316 may include 8 lens elements. The lens elements may be arranged in two or more axially separated subsets, e.g., three subsets, each subset being spaced apart from an adjacent subset along the optical axis. Image-space telecentricity may be achieved by adjusting optical parameters, e.g., surface curvature and axial spacing among the lens elements. The rays are controlled to converge through the corrector assembly 316 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 3B, the chief-ray angle versus field position demonstrates the image-space telecentricity at the image plane according to some embodiments of the RC telescope system in FIG. 3A. As shown in FIG. 3B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, or 1 degree. The CRA may be maintained below a specified value across, e.g., at least about 50%, at least about 60%, at least about 70%, at least about 80%, or at least about than 90% of the usable field of view. In certain embodiments, the ray angle as a function of field position corresponds to an optical configuration having an EFL of about 2500 mm and a CLA of about 200 mm.

FIG. 3B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 3B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 3C illustrates a calibrated geometric distortion field map plotted as vector displacement versus real ray image height across a field extending approximately ±20 mm in both X and Y directions. The distortion vectors may be substantially radially symmetric about the optical axis with small and smoothly varying magnitudes across the field. Referring to FIG. 3C., the map illustrates near-zero geometric distortion across the usable field of view according to some embodiments of the RC telescope system illustrated in FIG. 3A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.0275, the average distortion is approximately 0.00349, and the standard deviation is approximately 0.00358. FIG. 3C shows that, advantageously, the configuration of the RC telescope system achieves reduced geometric distortion across the usable field of view while maintaining image-space telecentricity.

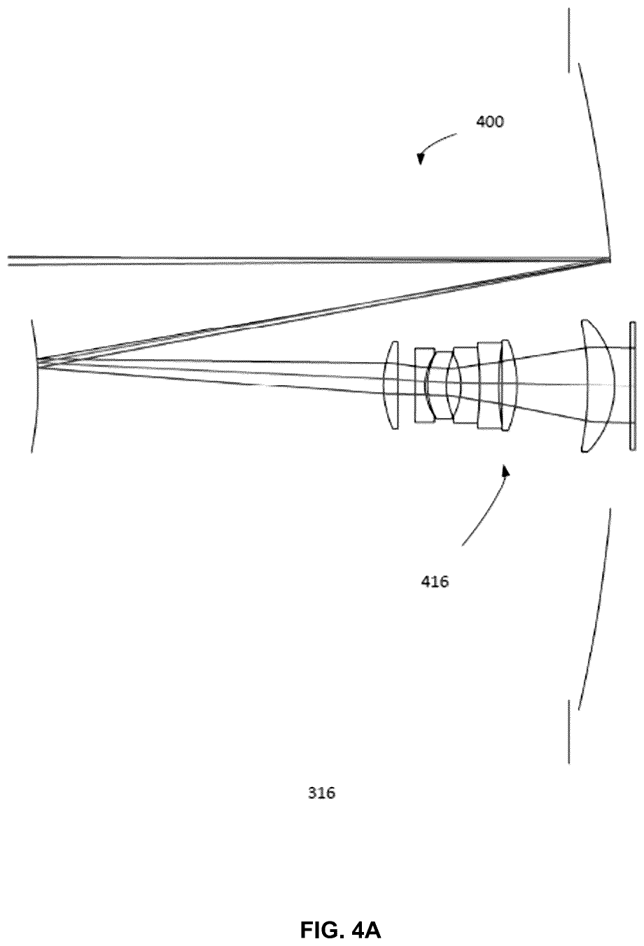

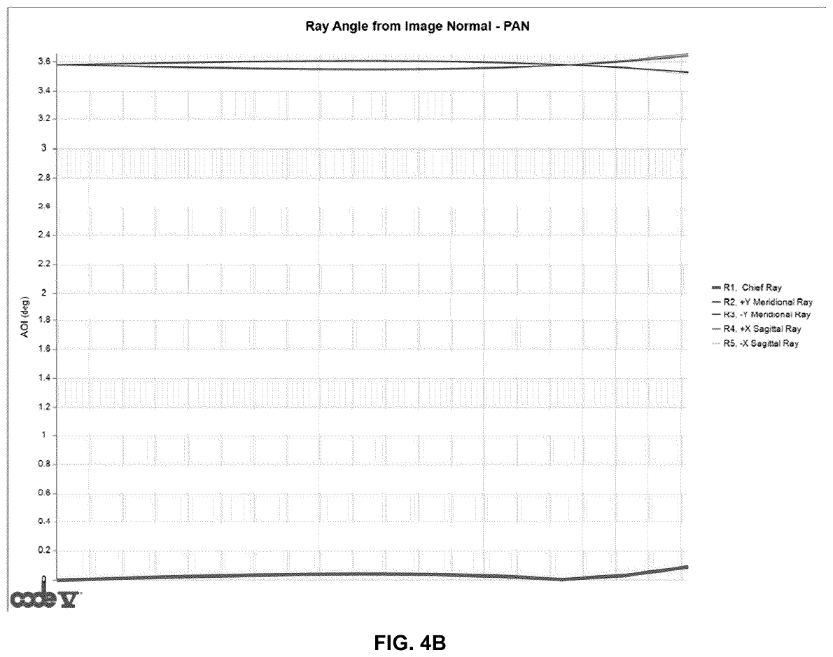

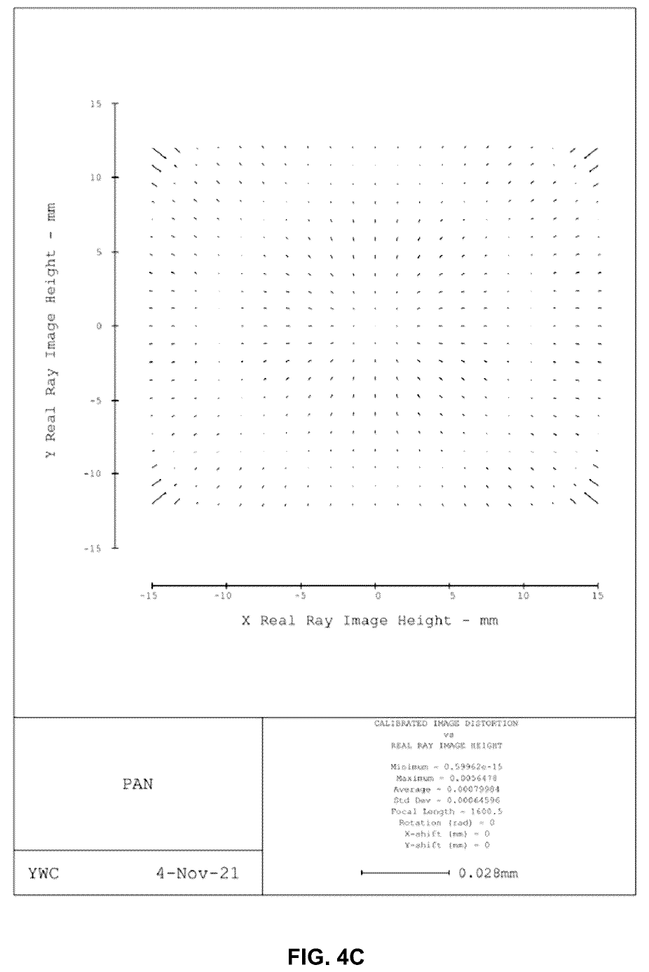

FIG. 4A is a schematic illustration showing another embodiment of a Ritchey-Chrétien telescope system 400 that may be used for space-based imaging. FIG. 4B illustrates an example chief-ray angle versus field position at image planes according to the FIG. 4A embodiment. FIG. 4C illustrates an example field distortion map of the FIG. 4A embodiment.

Referring to FIG. 4A, a schematic of an embodiment of a RC telescope system 400 is shown. In certain embodiments, the RC telescope system 400 may have an EFL of about 1600 mm and a CLA of about 200 mm. Unless otherwise indicated, the embodiments illustrated in FIG. 4A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

In certain embodiments, the corrector assembly 416 may be positioned along the optical axis between the primary mirror and the secondary mirror. All of the lens elements of the corrector assembly 416 may be positioned inside the outer diameter of the primary mirror and at least one of the lens elements is positioned closer to the primary mirror than the remaining lens elements. For example, as shown in FIG. 4A, the corrector assembly 416 may include 7 lens elements. The lens element positioned most proximal to the primary mirror along the optical axis may be space apart from the remaining 6 lens elements and is located closer to the primary mirror than the remaining lens elements. The lens elements may be arranged in two or more axially separated subsets, e.g., three subsets, each subset being spaced apart from an adjacent subset along the optical axis. Image-space telecentricity may be achieved by adjusting optical parameters, e.g., surface curvature and axial spacing among the lens elements. The rays are controlled to converge through the corrector assembly 416 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 4B, the chief-ray angle versus field position demonstrates the image-space telecentricity at the image plane according to some embodiments of the RC telescope system in FIG. 4A. As shown in FIG. 4B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, 1 degree, 0.5 degrees, 0.3 degrees, or 0.1 degrees. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 1600 mm and a CLA of about 200 mm.

FIG. 4B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 4B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 4C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 4C., the map illustrates near-zero geometric distortion across the usable field of view according to some embodiments of the RC telescope system illustrated in FIG. 4A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.056, the average distortion is approximately 0.0008, and the standard deviation is approximately 0.00065. FIG. 4C shows that, advantageously, the configuration of the RC telescope system achieves reduced geometric distortion across the usable field of view while maintaining image-space telecentricity.

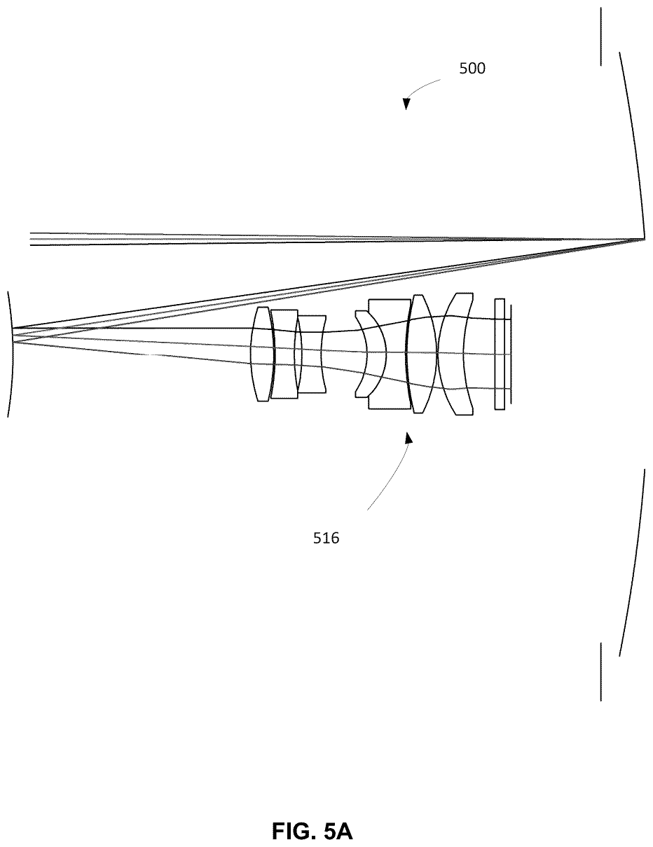

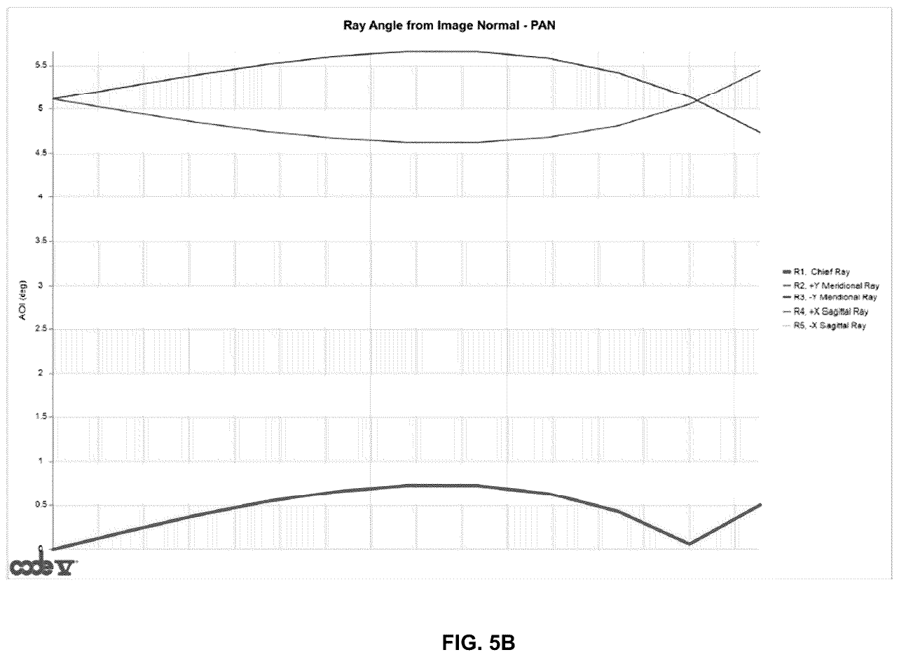

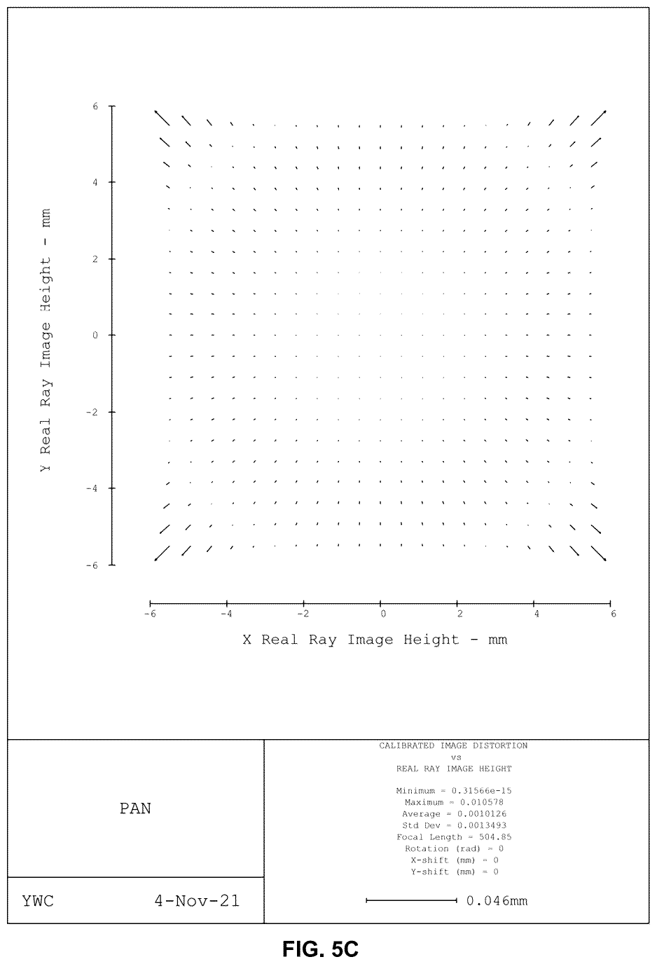

FIG. 5A is a schematic illustration showing another embodiment of a Ritchey-Chrétien telescope system 500 that may be used for space-based imaging. FIG. 5B illustrates an example chief-ray angle versus field position at image planes according to the FIG. 5A embodiment. FIG. 5C illustrates an example field distortion map of the FIG. 5A embodiment.

Referring to FIG. 5A, a schematic of an embodiment of a RC telescope system 500 is shown. In certain embodiments, the RC telescope system 500 may have an EFL of about 500 mm and a CLA of about 90 mm. Unless otherwise indicated, the embodiments illustrated in FIG. 5A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

In certain embodiments, the corrector assembly 516 may be positioned along the optical axis between the primary mirror and the secondary mirror. All of the lens elements of the corrector assembly 516 may be positioned inside the outer diameter of the primary mirror. For example, as shown in FIG. 5A, the lens elements are distributed within a middle region of the cavity defined by the primary and secondary mirrors, with selected axial spacings between adjacent lens elements. Image-space telecentricity may be achieved by adjusting optical parameters, e.g., surface curvature and axial spacing among the lens elements. The rays are controlled to converge through the corrector assembly 516 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 5B, the chief-ray angle versus field position demonstrates the image-space telecentricity at the image plane according to some embodiments of the RC telescope system in FIG. 5A. As shown in FIG. 5B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, or 1 degree. The CRA may be maintained below a specified value across, e.g., at least about 50%, at least about 60%, at least about 70%, at least about 80%, or at least about than 90% of the usable field of view. In certain embodiments, the ray angle as a function of field position corresponds to an optical configuration having an EFL of about 500 mm and a CLA of about 90 mm.

FIG. 5B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 5B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 5C illustrates a calibrated geometric distortion field map plotted as vector displacement versus real ray image height across a field extending approximately ±6 mm in both X and Y directions. The distortion vectors may be substantially radially symmetric about the optical axis with small and smoothly varying magnitudes across the field. Referring to FIG. 5C., the map illustrates near-zero geometric distortion across the usable field of view according to some embodiments of the RC telescope system illustrated in FIG. 5A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.0106, the average distortion is approximately 0.0010, and the standard deviation is approximately 0.00135. FIG. 5C shows that, advantageously, the configuration of the RC telescope system achieves reduced geometric distortion across the usable field of view while maintaining image-space telecentricity.

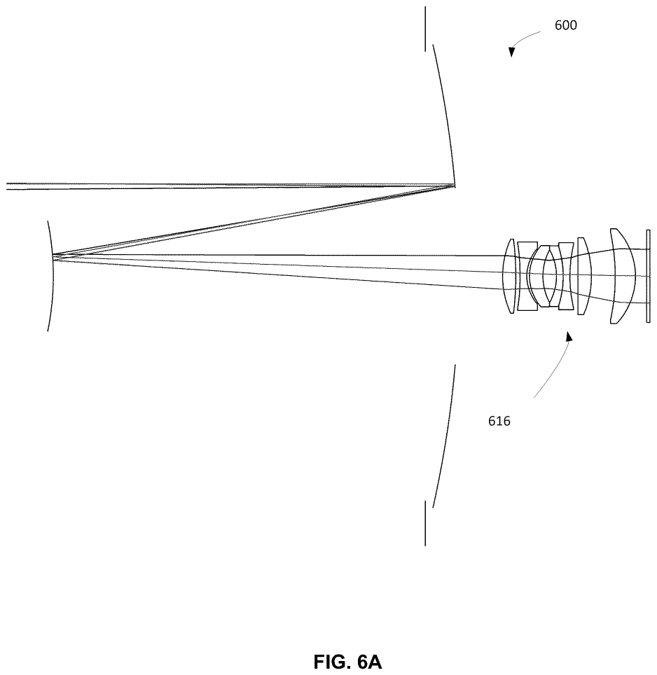

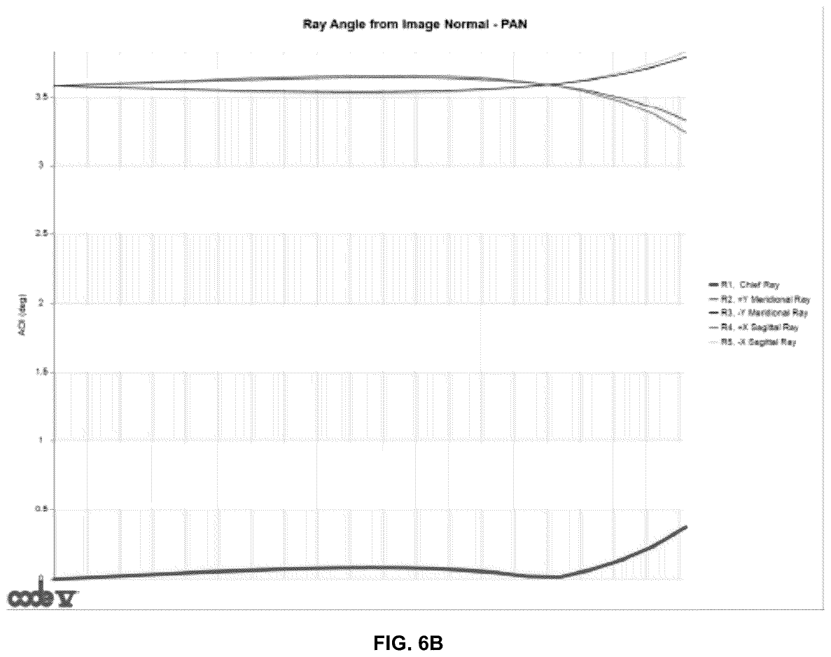

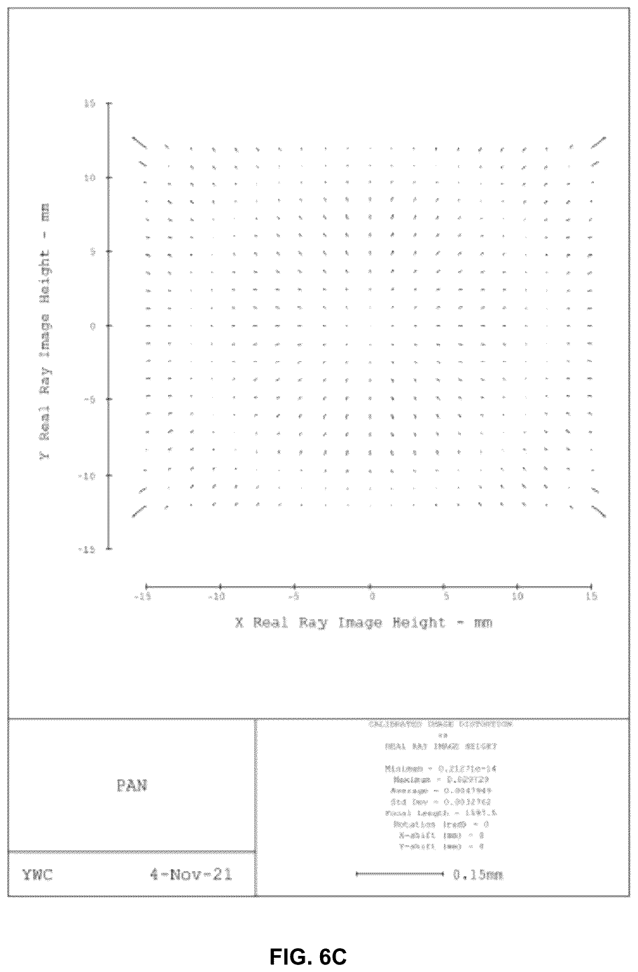

FIG. 6A is a schematic illustration showing another embodiment of a Ritchey-Chrétien telescope system 600 that may be used for space-based imaging. FIG. 6B illustrates an example chief-ray angle versus field position at image planes according to the FIG. 6A embodiment. FIG. 6C illustrates an example field distortion map of the FIG. 6A embodiment.

Referring to FIG. 6A, a schematic of an embodiment of a RC telescope system 600 is shown. In certain embodiments, the RC telescope system 600 may have an EFL of about 1600 mm, a CLA of about 200 mm, and a LEN of about 120. Unless otherwise indicated, the embodiments illustrated in FIG. 6A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

In certain embodiments, the corrector assembly 616 may be positioned along the optical axis between the secondary mirror and the image plane. All of the lens elements of the corrector assembly 616 may be positioned outside the outer diameter of the primary mirror. The corrector assembly may include a first end and a second end opposing each other. The mirror distance may be greater than a distance between the vertex of the primary mirror and the first end of the correct lens assembly. The first end is closer to the primary mirror than the second end. Image-space telecentricity may be achieved by adjusting optical parameters, e.g., surface curvature and axial spacing among the lens elements. The rays are controlled to converge through the corrector assembly 616 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 6B, the chief-ray angle versus field position demonstrates the image-space telecentricity at the image plane according to some embodiments of the RC telescope system in FIG. 6A. As shown in FIG. 6B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, or 1 degree. The CRA may be maintained below a specified value across, e.g., at least about 50%, at least about 60%, at least about 70%, at least about 80%, or at least about than 90% of the usable field of view. In certain embodiments, the ray angle as a function of field position corresponds to an optical configuration having an EFL of about 1600 mm, a CLA of about 200 mm, and a LEN of about 120.

FIG. 6B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 6B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 6C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 6C., the map illustrates near-zero geometric distortion across the usable field of view according to some embodiments of the RC telescope system illustrated in FIG. 6A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.0297, the average distortion is approximately 0.0048, and the standard deviation is approximately 0.0033. FIG. 6C shows that, advantageously, the configuration of the RC telescope system achieves reduced geometric distortion across the usable field of view while maintaining image-space telecentricity.

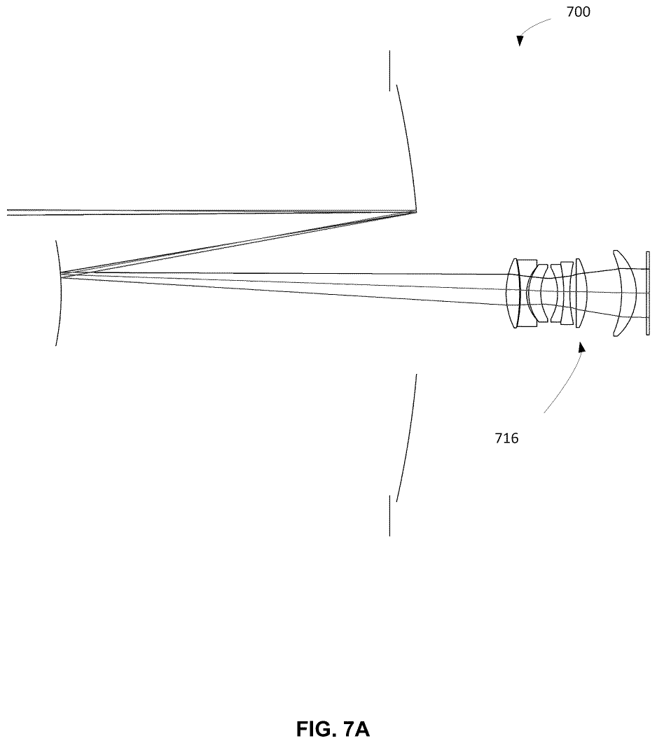

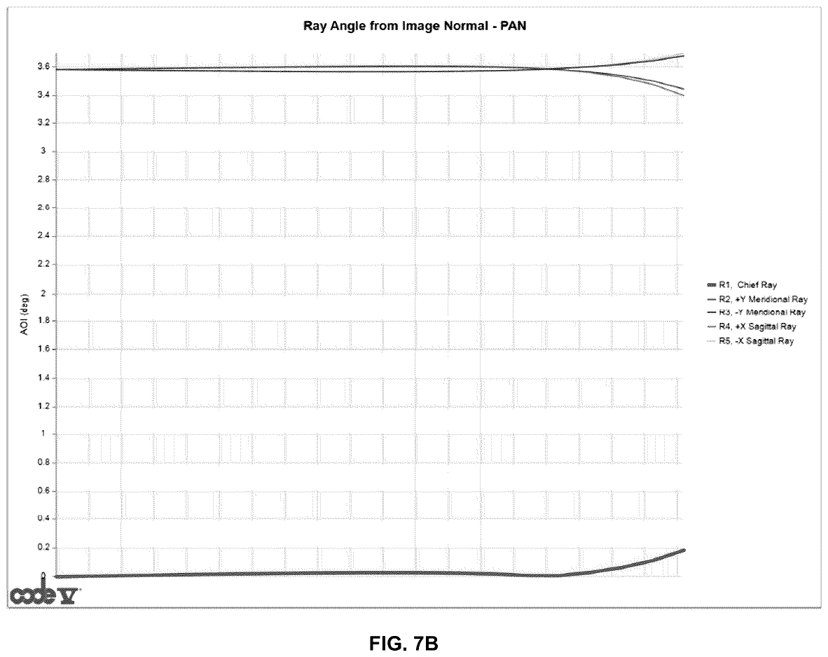

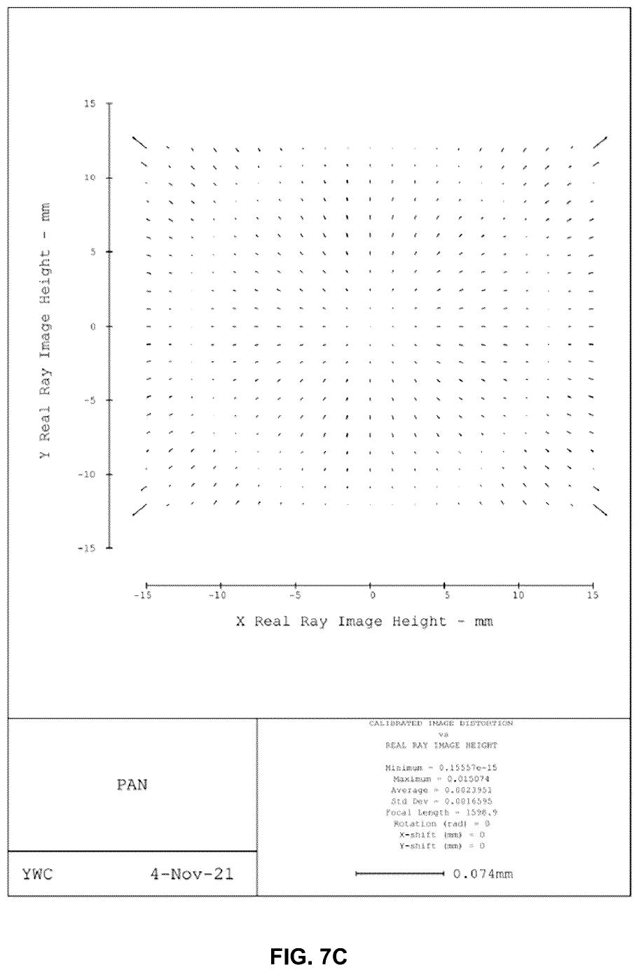

FIG. 7A is a schematic illustration showing another embodiment of a Ritchey-Chrétien telescope system 700 that may be used for space-based imaging. FIG. 7B illustrates an example chief-ray angle versus field position at image planes according to the FIG. 7A embodiment. FIG. 7C illustrates an example field distortion map of the FIG. 7A embodiment.

Referring to FIG. 7A, a schematic of an embodiment of a RC telescope system 700 is shown. In certain embodiments, the RC telescope system 700 may have an EFL of about 1600 mm, a CLA of about 200 mm, and a LEN of about 220. Unless otherwise indicated, the embodiments illustrated in FIG. 7A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

In certain embodiments, the corrector assembly 716 may be positioned along the optical axis between the secondary mirror and the image plane. All of the lens elements of the corrector assembly 716 may be positioned outside the outer diameter of the primary mirror. The corrector assembly may include a first end and a second end opposing each other. The mirror distance may be greater than a distance between the vertex of the primary mirror and the first end of the correct assembly. The first end is closer to the primary mirror than the second end. Image-space telecentricity may be achieved by adjusting optical parameters, e.g., surface curvature and axial spacing among the lens elements. The rays are controlled to converge through the corrector assembly 716 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 7B, the chief-ray angle versus field position demonstrates the image-space telecentricity at the image plane according to some embodiments of the RC telescope system in FIG. 7A. As shown in FIG. 7B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, or 1 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 1600 mm, a CLA of about 200 mm, and a LEN of about 220.

FIG. 7B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 7B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 7C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 7C., the map illustrates near-zero geometric distortion across the usable field of view according to some embodiments of the RC telescope system illustrated in FIG. 7A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.0151, the average distortion is approximately 0.003, and the standard deviation is approximately 0.0017. FIG. 7C shows that, advantageously, the configuration of the RC telescope system achieves reduced geometric distortion across the usable field of view while maintaining image-space telecentricity.

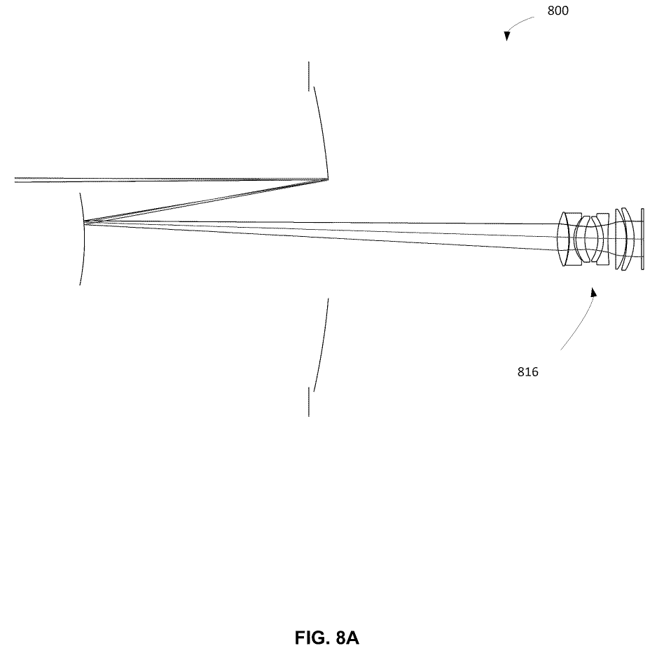

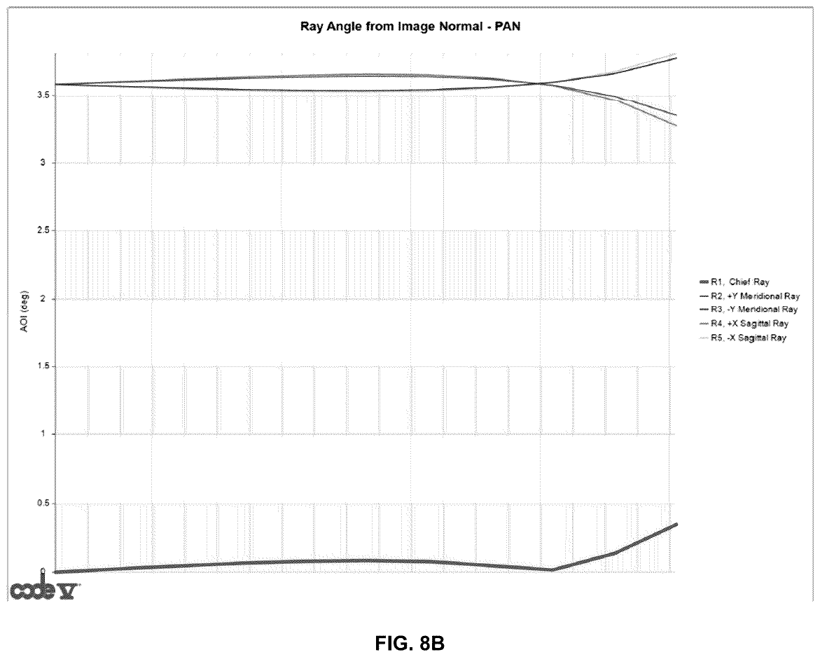

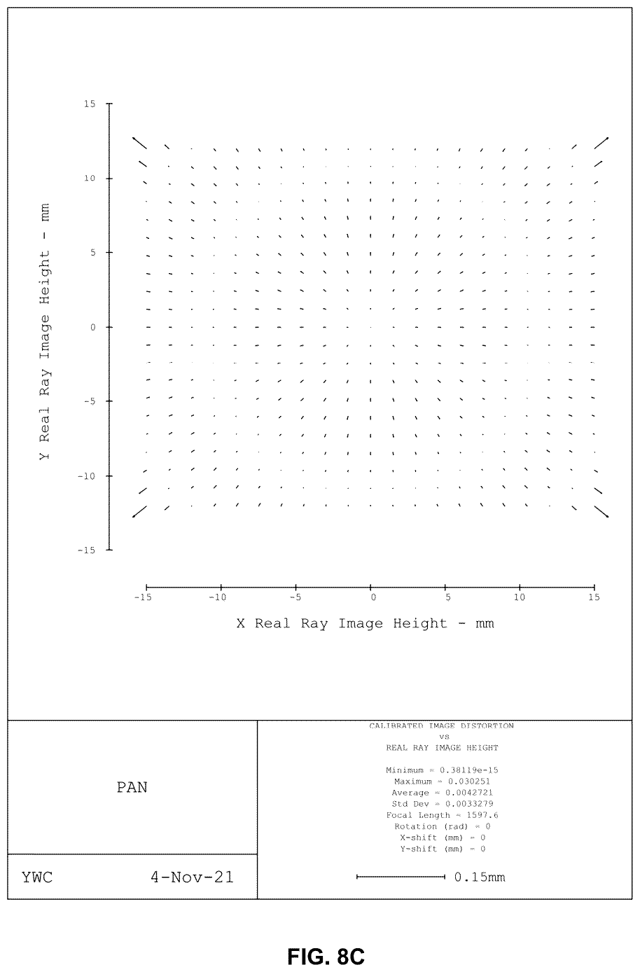

FIG. 8A is a schematic illustration showing another embodiment of a Ritchey-Chrétien telescope system 800 that may be used for space-based imaging. FIG. 8B illustrates an example chief-ray angle versus field position at image planes according to the FIG. 8A embodiment. FIG. 8C illustrates an example field distortion map of the FIG. 8A embodiment.

Referring to FIG. 8A, a schematic of an embodiment of a RC telescope system 800 is shown. In certain embodiments, the RC telescope system 800 may have an EFL of about 1600 mm, a CLA of about 200 mm, and a LEN of about 320. Unless otherwise indicated, the embodiments illustrated in FIG. 8A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

In certain embodiments, the corrector assembly 816 may be positioned along the optical axis between the secondary mirror and the image plane. All of the lens elements of the corrector assembly 816 may be positioned outside the outer diameter of the primary mirror. In certain embodiments, the corrector assembly 816 is positioned farther from the primary mirror and closer to the image plane along the optical axis. Image-space telecentricity may be achieved by adjusting optical parameters, e.g., surface curvature and axial spacing among the lens elements. The rays are controlled to converge through the corrector assembly 816 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 8B, the chief-ray angle versus field position demonstrates the image-space telecentricity at the image plane according to some embodiments of the RC telescope system in FIG. 8A. As shown in FIG. 8B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, or 1 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 1600 mm, a CLA of about 200 mm, and a LEN of about 320.

FIG. 8B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 8B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 8C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 8C., the map illustrates near-zero geometric distortion across the usable field of view according to some embodiments of the RC telescope system illustrated in FIG. 8A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.0303, the average distortion is approximately 0.0043, and the standard deviation is approximately 0.0033. FIG. 8C shows that, advantageously, the configuration of the RC telescope system achieves reduced geometric distortion across the usable field of view while maintaining image-space telecentricity.

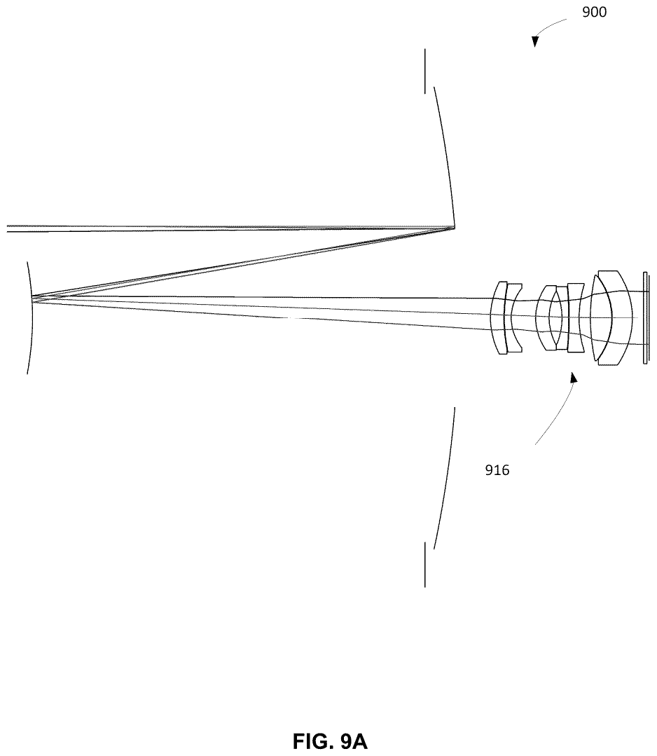

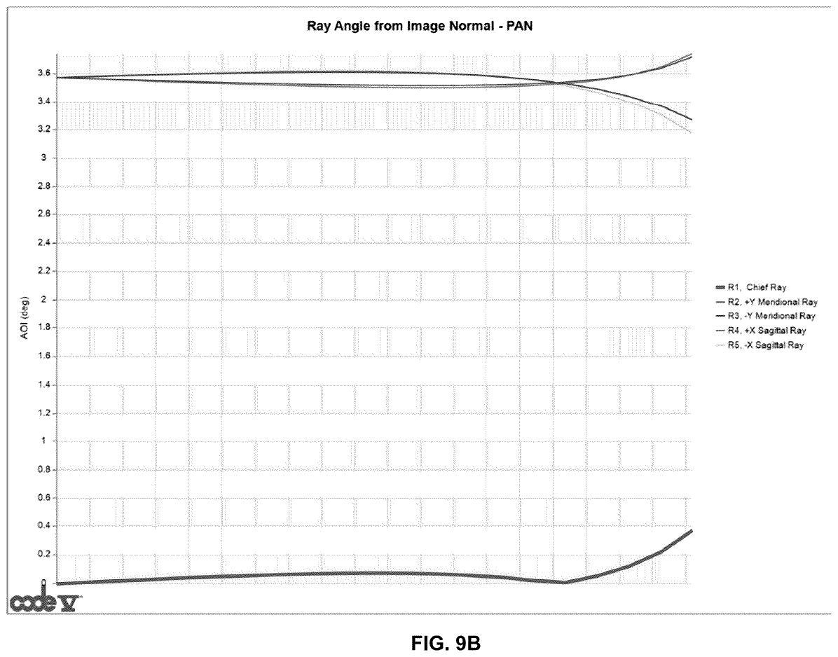

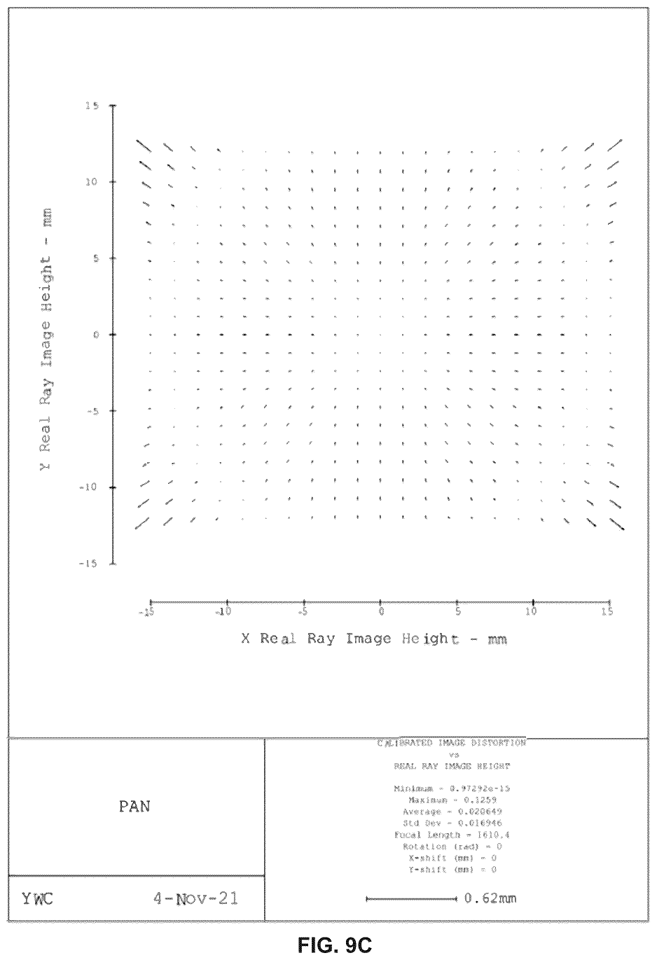

FIG. 9A is a schematic illustration showing another embodiment of a Ritchey-Chrétien telescope system 900 that may be used for space-based imaging. FIG. 9B illustrates an example chief-ray angle versus field position at image planes according to the FIG. 9A embodiment. FIG. 9C illustrates an example field distortion map of the FIG. 9A embodiment.

Referring to FIG. 9A, a schematic of an embodiment of an RC telescope system 900 is shown. In certain embodiments, the RC telescope system 900 may have an EFL of about 1600 mm and a CLA of about 200 mm. Unless otherwise indicated, the embodiments illustrated in FIG. 9A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

In certain embodiments, the corrector assembly 916 may be positioned along the optical axis between the secondary mirror and the image plane. All of the lens elements of the corrector assembly 916 may be positioned outside the outer diameter of the primary mirror. The corrector assembly may include a first end and a second end opposing each other. The mirror distance may be greater than a distance between the vertex of the primary mirror and the first end of the correct assembly. The first end is closer to the primary mirror than the second end. Image-space telecentricity may be achieved by adjusting optical parameters, e.g., surface curvature and axial spacing among the lens elements. The rays are controlled to converge through the corrector assembly 916 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 9B, the chief-ray angle versus field position demonstrates the image-space telecentricity at the image plane according to some embodiments of the RC telescope system in FIG. 9A. As shown in FIG. 9B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, or 1 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 1600 mm and a CLA of about 200 mm.

FIG. 9B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 9B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 9C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 9C., the map illustrates near-zero geometric distortion across the usable field of view according to some embodiments of the RC telescope system illustrated in FIG. 9A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.126, the average distortion is approximately 0.0.0206, and the standard deviation is approximately 0.0.0169. FIG. 9C shows that, advantageously, the configuration of the RC telescope system achieves reduced geometric distortion across the usable field of view while maintaining image-space telecentricity.

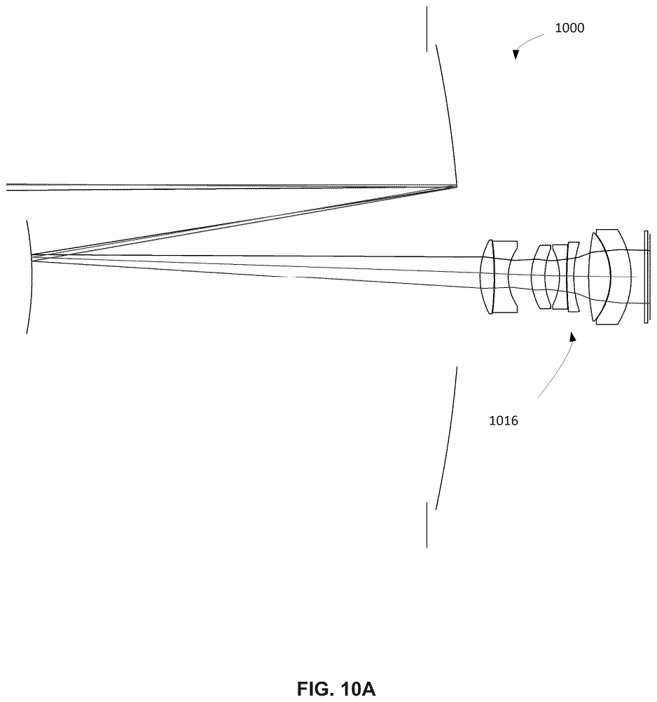

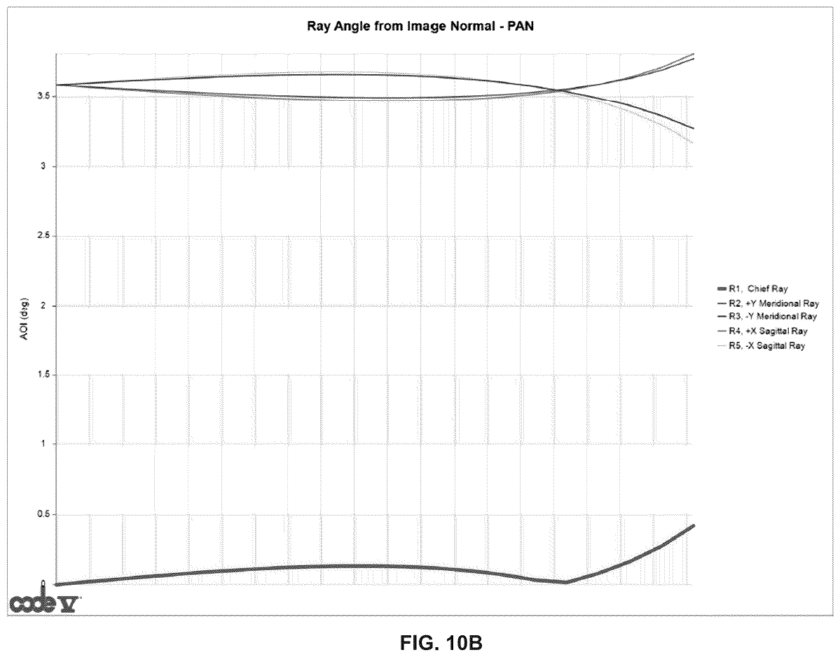

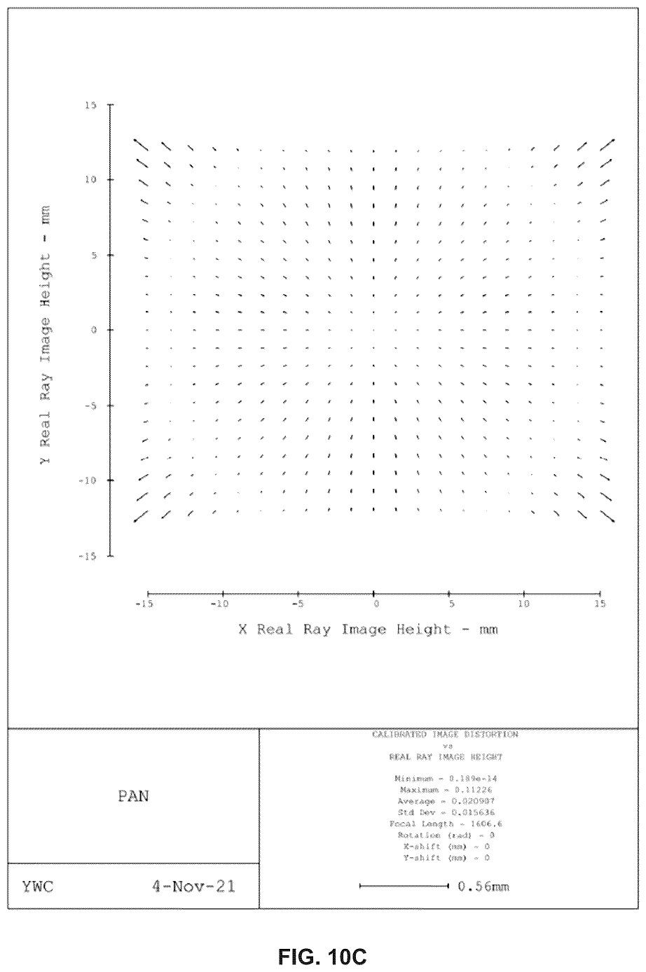

FIG. 10A is a schematic illustration showing another embodiment of a Ritchey-Chrétien telescope system 1000 that may be used for space-based imaging. FIG. 10B illustrates an example chief-ray angle versus field position at image planes according to the FIG. 10A embodiment. FIG. 10C illustrates an example field distortion map of the FIG. 10A embodiment.

Referring to FIG. 10A, a schematic of an embodiment of a RC telescope system 1000 is shown. In certain embodiments, the RC telescope system 1000 may have an EFL of about 1600 mm and a CLA of about 200 mm. Unless otherwise indicated, the embodiments illustrated in FIG. 10A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

As shown in FIG. 10A, the corrector assembly 1016 may include at least 6 lens elements, for example, at least 6, 7, 8, 9, 10, 11, or 12, 13, 14, 15, 16, 17, 18, 19, or 20, or more lens elements. In certain embodiments, the corrector assembly 1016 may be positioned along the optical axis between the secondary mirror and the image plane. All of the lens elements of the corrector assembly 1016 may be positioned outside the outer diameter of the primary mirror. Image-space telecentricity may be achieved by adjusting optical parameters, e.g., surface curvature and axial spacing among the lens elements. The rays are controlled to converge through the corrector assembly 1016 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 10B, the chief-ray angle versus field position demonstrates the image-space telecentricity at the image plane according to some embodiments of the RC telescope system in FIG. 10A. As shown in FIG. 10B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, or 1 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 1600 mm and a CLA of about 200 mm.

FIG. 10B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 10B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 10C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 10C., the map illustrates near-zero geometric distortion across the usable field of view according to some embodiments of the RC telescope system illustrated in FIG. 10A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.112, the average distortion is approximately 0.0209, and the standard deviation is approximately 0.0156. FIG. 10C shows that, advantageously, the configuration of the RC telescope system achieves reduced geometric distortion across the usable field of view while maintaining image-space telecentricity.

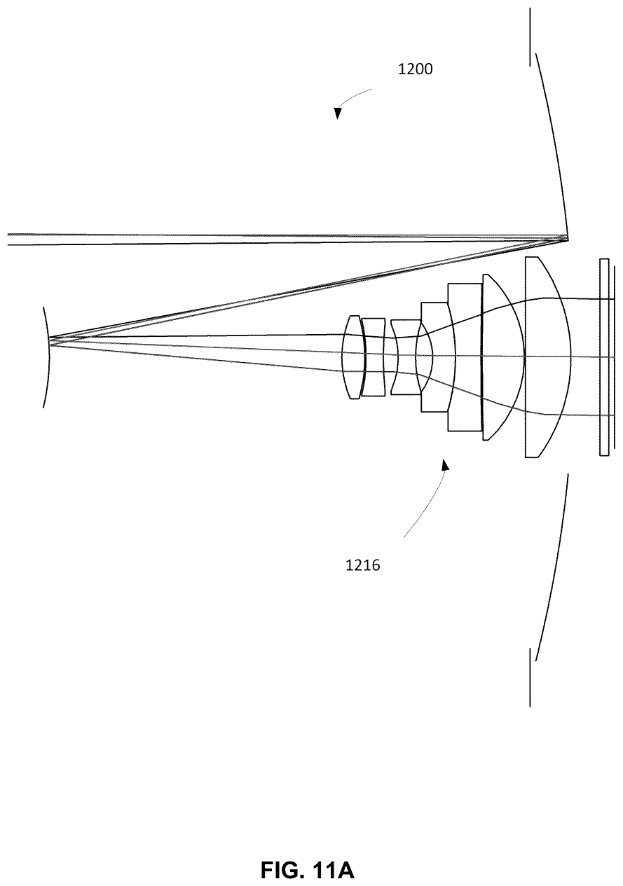

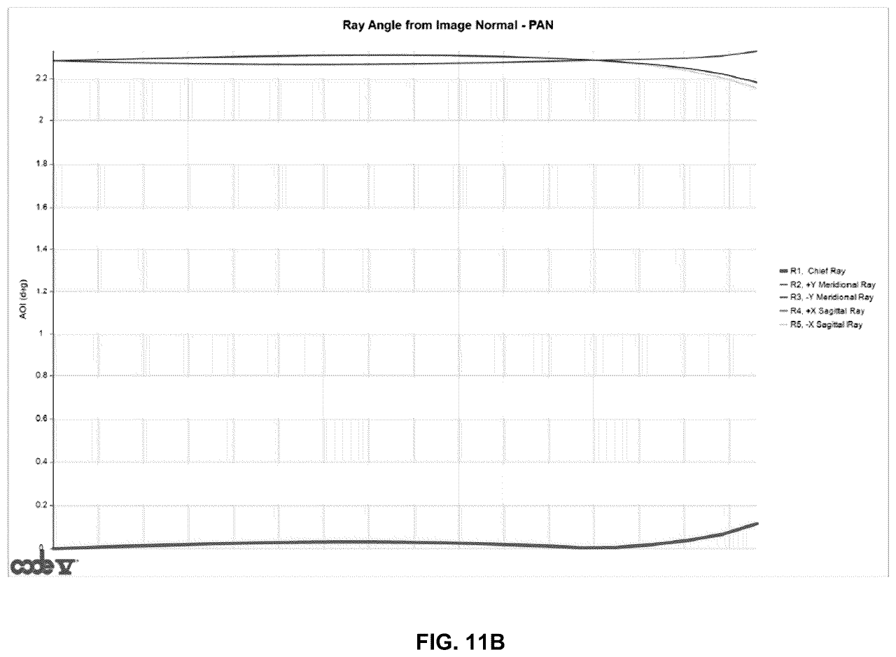

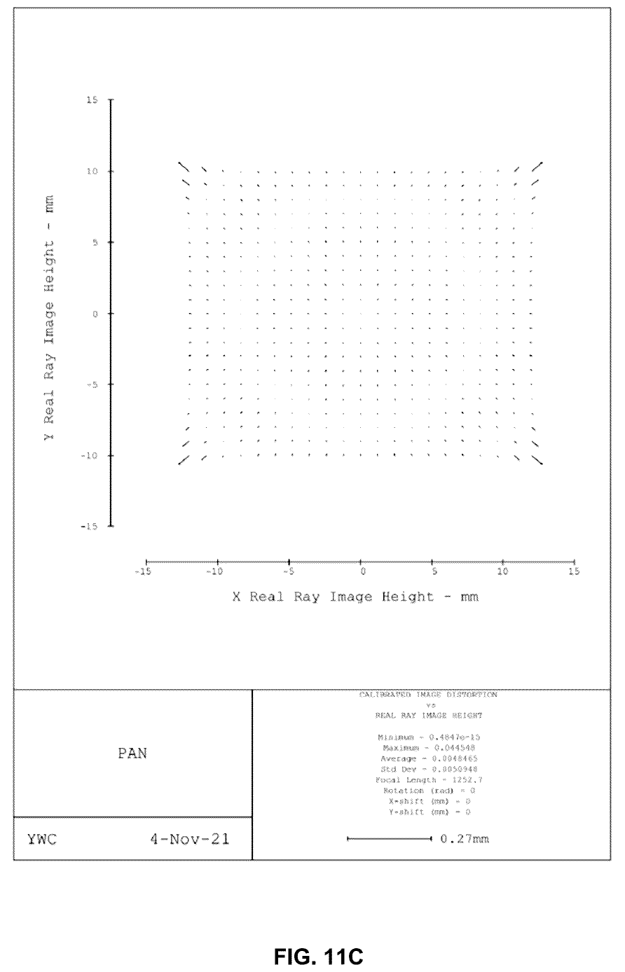

FIG. 11A is a schematic illustration showing another embodiment of a Ritchey-Chrétien telescope system 1200 that may be used for space-based imaging. FIG. 11B illustrates an example chief-ray angle versus field position at image planes according to the FIG. 11A embodiment. FIG. 11C illustrates an example field distortion map of the FIG. 11A embodiment.

Referring to FIG. 11A, a schematic of an embodiment of a RC telescope system 1200 is shown. In certain embodiments, the RC telescope system 1200 may have an EFL of about 1250 mm and a CLA of about 100 mm. Unless otherwise indicated, the embodiments illustrated in FIG. 11A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

FIG. 11A depicts an embodiment having a moderate effective focal length and an adjusted curvature of the secondary mirror. In certain embodiments, the corrector assembly 1216 may be positioned along the optical axis between the primary mirror and the secondary mirror. The lens elements of the corrector assembly 1216 may be positioned closer to the primary mirror than to the secondary mirror. Image-space telecentricity may be achieved by adjusting optical parameters, e.g., surface curvature and axial spacing among the lens elements. The rays are controlled to converge through the corrector assembly 1216 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 11B, the chief-ray angle versus field position demonstrates the image-space telecentricity at the image plane according to some embodiments of the RC telescope system in FIG. 11A. As shown in FIG. 11B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, or 1 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 1250 mm and a CLA of about 100 mm.

FIG. 11B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 11B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 11C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 11C., the map illustrates near-zero geometric distortion across the usable field of view according to some embodiments of the RC telescope system illustrated in FIG. 11A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.0445, the average distortion is approximately 0.0048, and the standard deviation is approximately 0.0051. FIG. 11C shows that, advantageously, the configuration of the RC telescope system achieves reduced geometric distortion across the usable field of view while maintaining image-space telecentricity.

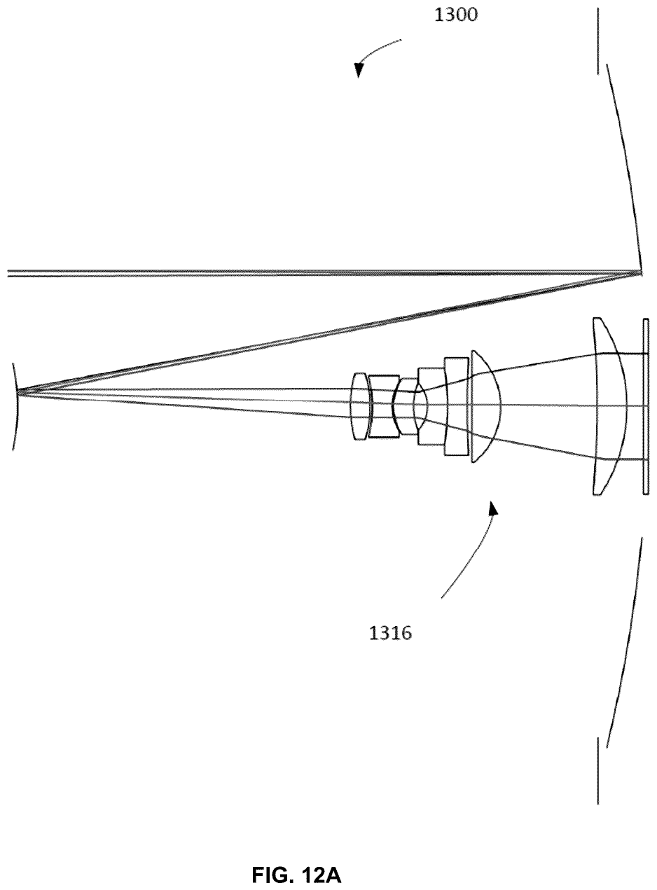

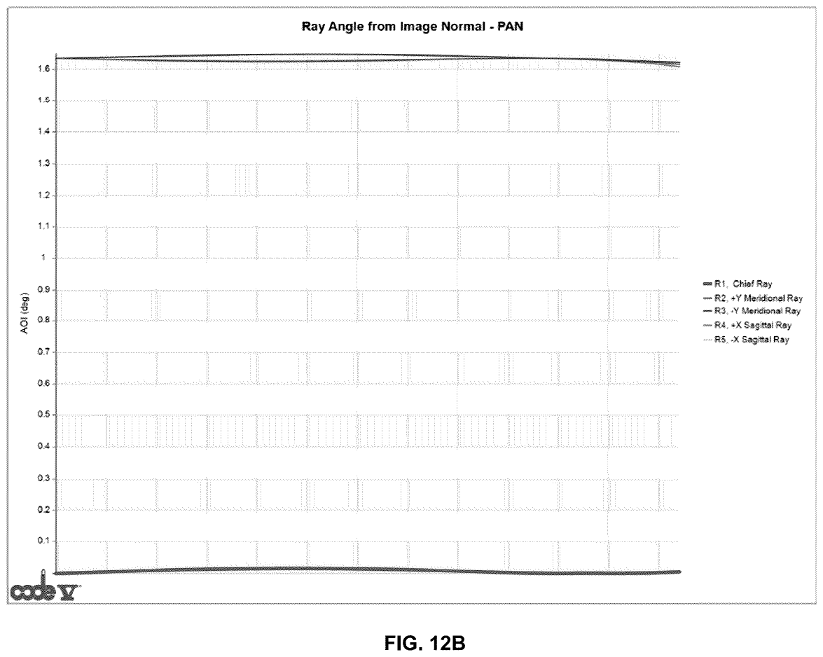

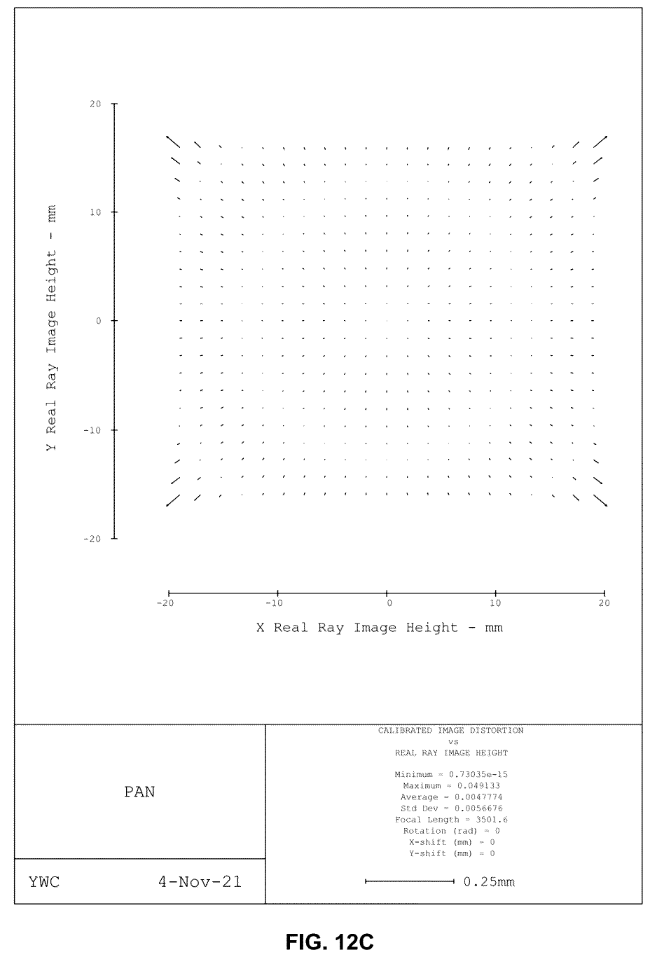

FIG. 12A is a schematic illustration showing another embodiment of a Ritchey-Chrétien telescope system 1300 that may be used for space-based imaging. FIG. 12B illustrates an example chief-ray angle versus field position at image planes according to the FIG. 12A embodiment. FIG. 12C illustrates an example field distortion map of the FIG. 12A embodiment.

Referring to FIG. 12A, a schematic of an embodiment of a RC telescope system 1300 is shown. In certain embodiments, the RC telescope system 1300 may have an EFL of about 3500 mm and a CLA of about 200 mm. Unless otherwise indicated, the embodiments illustrated in FIG. 12A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

As shown in FIG. 12A, the corrector assembly 1316 may include at least 6 lens elements, for example, at least 6, 7, 8, 9, 10, 11, or 12, 13, 14, 15, 16, 17, 18, 19, or 20, or more lens elements. In certain embodiments, the corrector assembly 1316 may be positioned along the optical axis between the primary mirror and the secondary mirror. At least one of the lens elements of the corrector assembly 1316 may be positioned closer to the primary mirror than the remaining lens elements. Image-space telecentricity may be achieved by adjusting optical parameters, e.g., surface curvature and axial spacing among the lens elements. The rays are controlled to converge through the corrector assembly 1316 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 12B, the chief-ray angle versus field position demonstrates the image-space telecentricity at the image plane according to some embodiments of the RC telescope system in FIG. 12A. As shown in FIG. 12B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, 1 degree, or 0.5 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 3500 mm and a CLA of about 200 mm.

FIG. 12B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 0.5 degree across at least 70%, 80%, or 90% of the active image height. As shown in FIG. 12B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 12C illustrates field distortion maps of various embodiments. Specifically, FIG. 12C illustrates a calibrated geometric distortion field map plotted as vector displacement versus real ray image height across a field extending approximately ±20 mm in both X and Y directions. The distortion vectors may be substantially radially symmetric about the optical axis with small and smoothly varying magnitudes across the field. Referring to FIG. 12C., the map illustrates near-zero geometric distortion across the usable field of view according to some embodiments of the RC telescope system illustrated in FIG. 12A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.0491, the average distortion is approximately 0.00478, and the standard deviation is approximately 0.00567. FIG. 12C shows that, advantageously, the configuration of the RC telescope system achieves reduced geometric distortion across the usable field of view while maintaining image-space telecentricity.

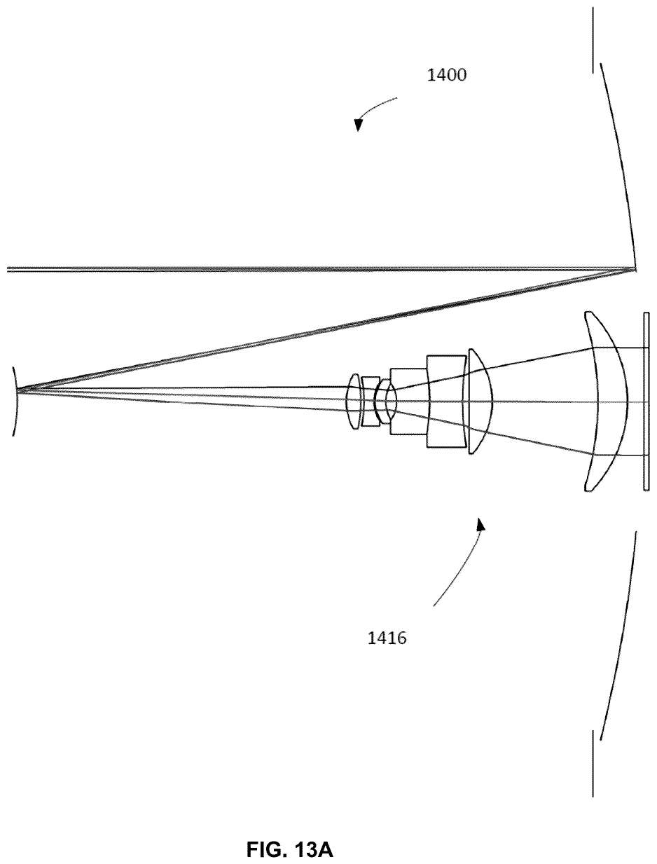

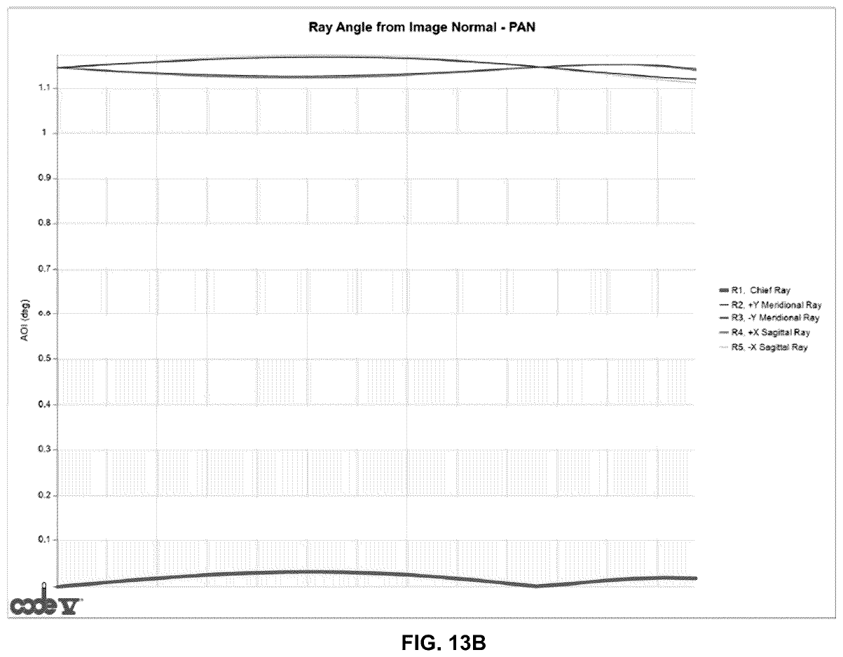

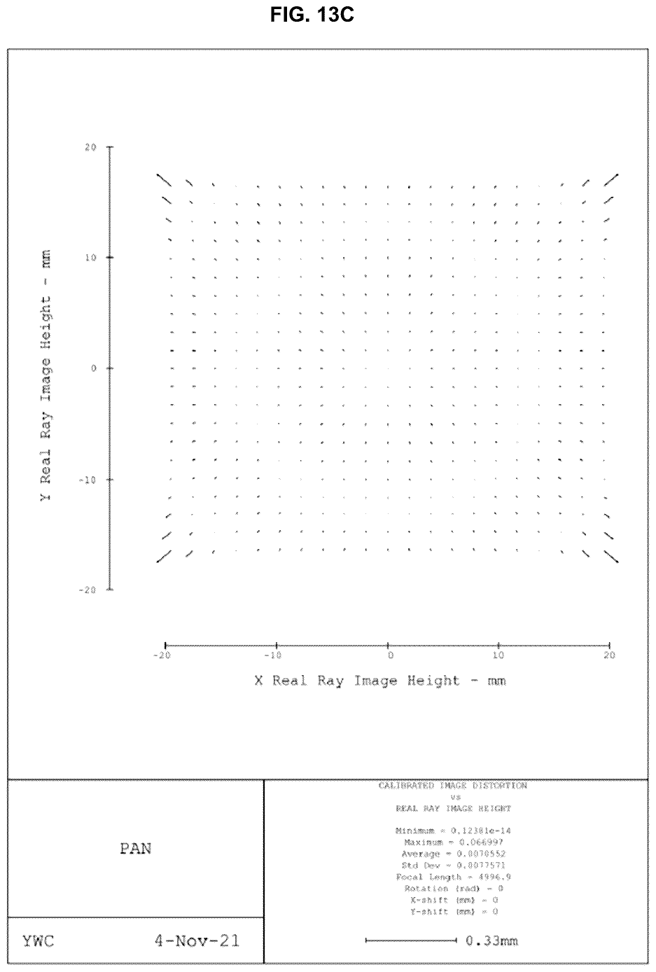

FIG. 13A is a schematic illustration showing another embodiment of a Ritchey-Chrétien telescope system 1400 that may be used for space-based imaging. FIG. 13B illustrates an example chief-ray angle versus field position at image planes according to the FIG. 13A embodiment. FIG. 13C illustrates an example field distortion map of the FIG. 13A embodiment.

Referring to FIG. 13A, a schematic of an embodiment of a RC telescope system 1400 is shown. In certain embodiments, the RC telescope system 1400 may have an EFL of about 5000 mm and a CLA of about 200 mm. Unless otherwise indicated, the embodiments illustrated in FIG. 13A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

In certain embodiments, the corrector assembly 1416 may be positioned along the optical axis between the primary mirror and the secondary mirror. At least one of the lens elements of the corrector assembly 1416 may be positioned closer to the primary mirror than the remaining lens elements. Image-space telecentricity may be achieved by adjusting optical parameters, e.g., surface curvature and axial spacing among the lens elements. The rays are controlled to converge through the corrector assembly 1416 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 13B, the chief-ray angle versus field position demonstrates the image-space telecentricity at the image plane according to some embodiments of the RC telescope system in FIG. 13A. As shown in FIG. 13B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, 1 degree, or 0.5 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 5000 mm and a CLA of about 200 mm.

FIG. 13B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 13B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 13C illustrates a calibrated geometric distortion field map plotted as vector displacement versus real ray image height across a field extending approximately ±20 mm in both X and Y directions. The distortion vectors may be substantially radially symmetric about the optical axis with small and smoothly varying magnitudes across the field. Referring to FIG. 13C., the map illustrates near-zero geometric distortion across the usable field of view according to some embodiments of the RC telescope system illustrated in FIG. 13A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.07, the average distortion is approximately 0.007, and the standard deviation is approximately 0.0078. FIG. 13C shows that, advantageously, the configuration of the RC telescope system achieves reduced geometric distortion across the usable field of view while maintaining image-space telecentricity.

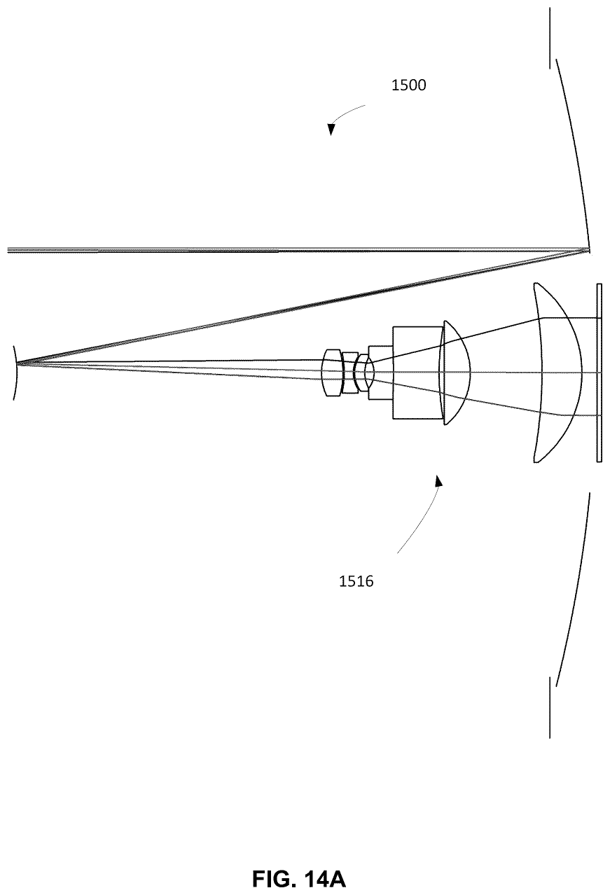

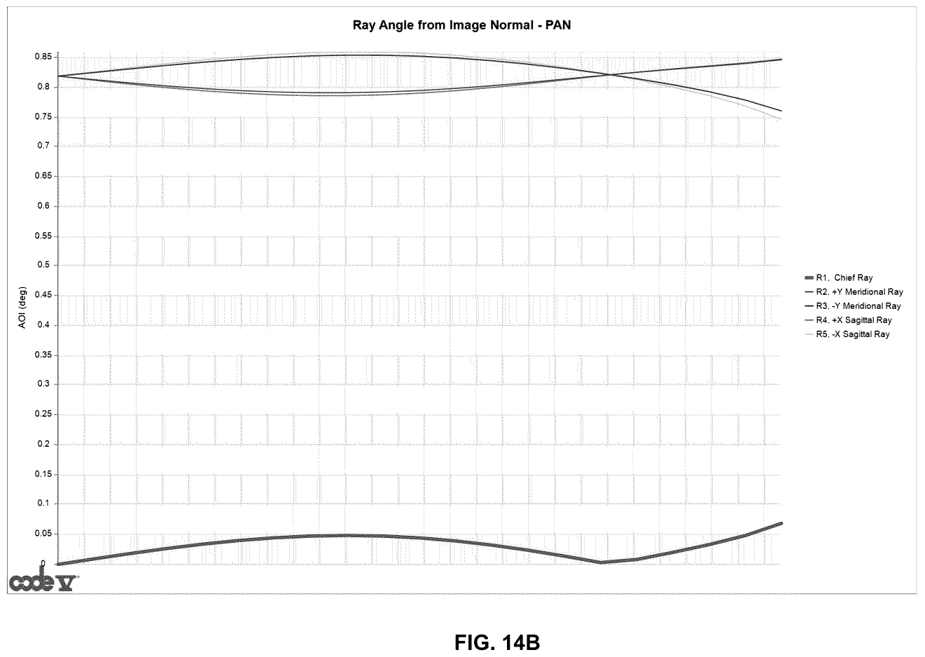

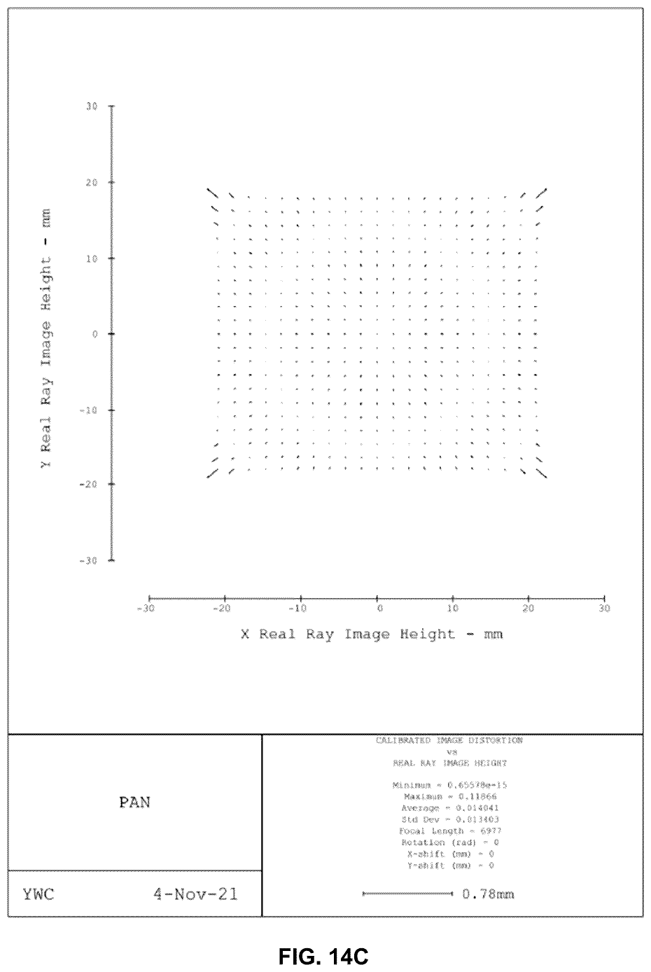

FIG. 14A is a schematic illustration showing another embodiment of a Ritchey-Chrétien telescope system 1500 that may be used for space-based imaging. FIG. 14B illustrates an example chief-ray angle versus field position at image planes according to the FIG. 14A embodiment. FIG. 14C illustrates an example field distortion map of the FIG. 14A embodiment.

Referring to FIG. 14A, a schematic of an embodiment of a RC telescope system 1500 is shown. In certain embodiments, the RC telescope system 1500 may have an EFL of about 7000 mm and a CLA of about 200 mm. Unless otherwise indicated, the embodiments illustrated in FIG. 14A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

In certain embodiments, the corrector assembly 1516 may be positioned along the optical axis between the primary mirror and the secondary mirror. At least one of the lens elements of the corrector assembly 1516 may be positioned closer to the primary mirror than the remaining lens elements. Image-space telecentricity may be achieved by adjusting optical parameters, e.g., surface curvature and axial spacing among the lens elements. The rays are controlled to converge through the corrector assembly 1516 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 14B, the chief-ray angle versus field position demonstrates the image-space telecentricity at the image plane according to some embodiments of the RC telescope system in FIG. 14A. As shown in FIG. 14B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, 1 degree, or 0.5 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 7000 mm and a CLA of about 200 mm.

FIG. 14B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 14B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 14C illustrates a calibrated geometric distortion field map plotted as vector displacement versus real ray image height across a field extending approximately ±25 mm in both X and Y directions. The distortion vectors may be substantially radially symmetric about the optical axis with small and smoothly varying magnitudes across the field. Referring to FIG. 14C., the map illustrates near-zero geometric distortion across the usable field of view according to some embodiments of the RC telescope system illustrated in FIG. 14A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.1187, the average distortion is approximately 0.0140, and the standard deviation is approximately 0.0134. FIG. 14C shows that, advantageously, the configuration of the RC telescope system achieves reduced geometric distortion across the usable field of view while maintaining image-space telecentricity.

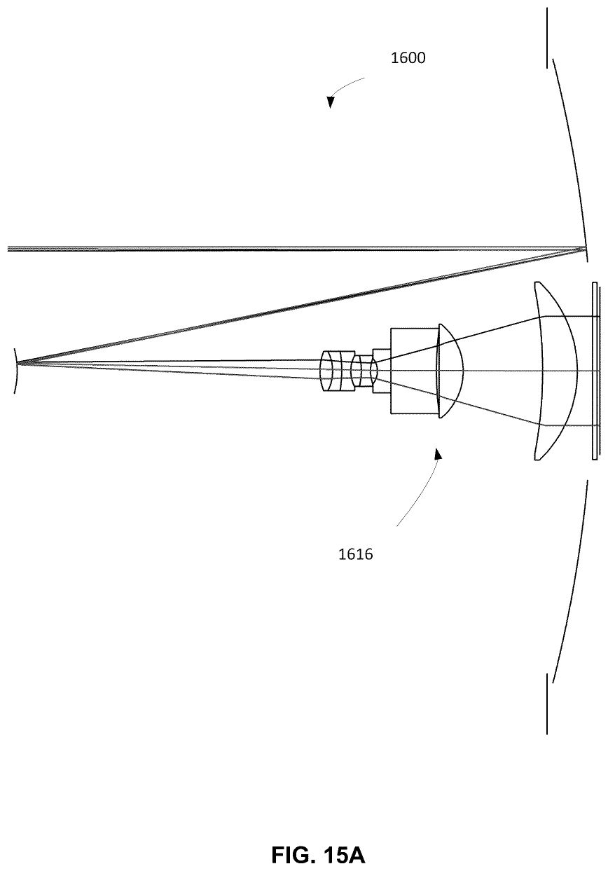

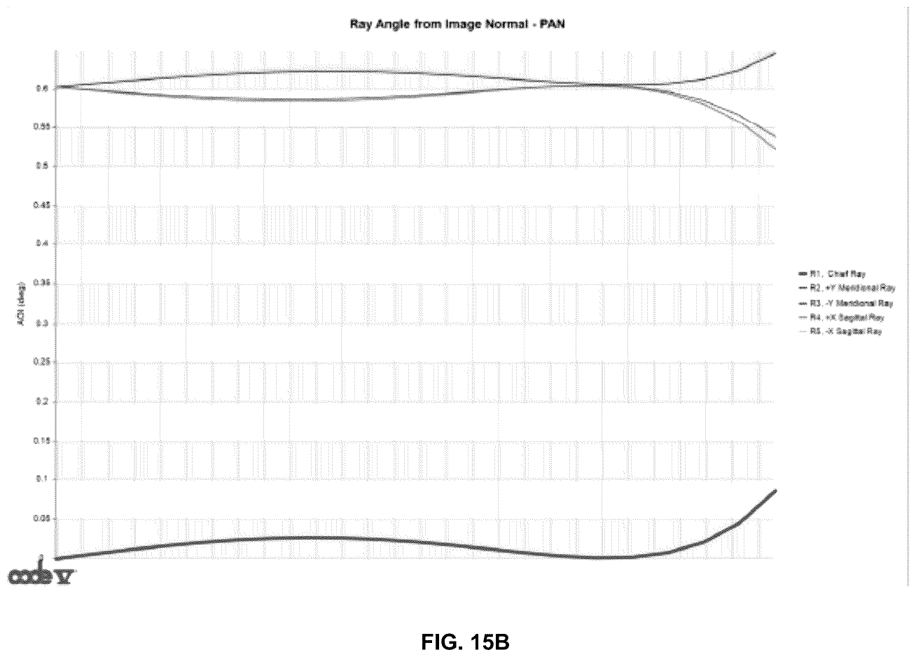

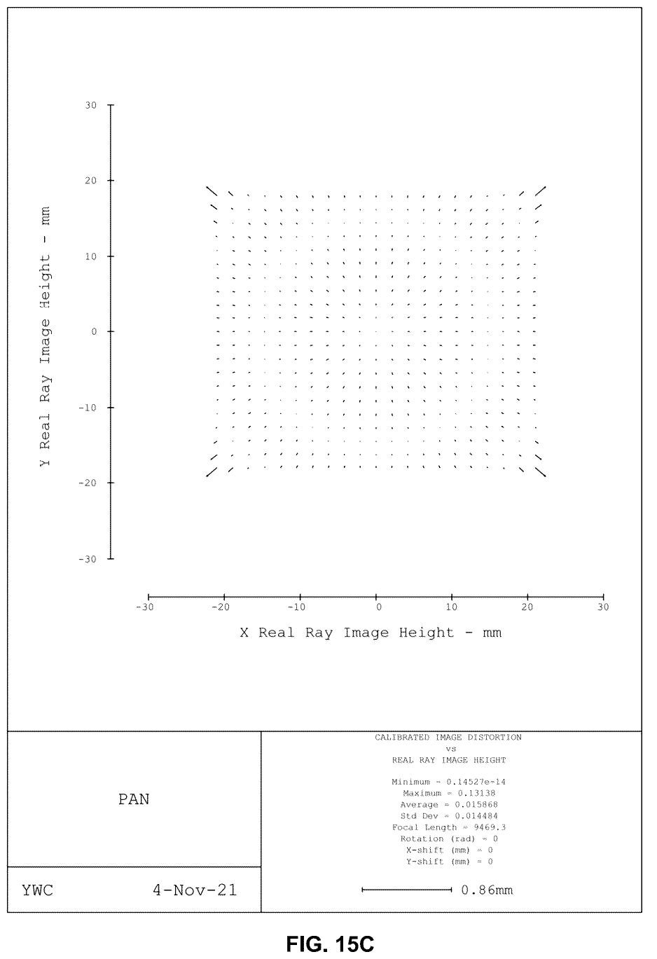

FIG. 15A is a schematic illustration showing another embodiment of a Ritchey-Chrétien telescope system 1600 that may be used for space-based imaging. FIG. 15B illustrates an example chief-ray angle versus field position at image planes according to the FIG. 15A embodiment. FIG. 15C illustrates an example field distortion map of the FIG. 15A embodiment.

Referring to FIG. 15A, a schematic of an embodiment of a RC telescope system 1600 is shown. In certain embodiments, the RC telescope system 1600 may have an EFL of about 9500 mm and a CLA of about 200 mm. Unless otherwise indicated, the embodiments illustrated in FIG. 15A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

FIG. 15A illustrates an embodiment having an ultra-long focal effective length with improved mirror despace stability. In certain embodiments, the corrector assembly 1616 may be positioned along the optical axis between the primary mirror and the secondary mirror. At least one of the lens elements of the corrector assembly 1616 may be positioned closer to the primary mirror than the remaining lens elements. Image-space telecentricity may be achieved by adjusting optical parameters, e.g., surface curvature and axial spacing among the lens elements. The rays are controlled to converge through the corrector assembly 1616 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 15B, the chief-ray angle versus field position demonstrates the image-space telecentricity at the image plane according to some embodiments of the RC telescope system in FIG. 15A. As shown in FIG. 15B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, 1 degree, or 0.5 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 9500 mm and a CLA of about 200 mm.

FIG. 15B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 15B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 15C illustrates a calibrated geometric distortion field map plotted as vector displacement versus real ray image height across a field extending approximately ±25 mm in both X and Y directions. The distortion vectors may be substantially radially symmetric about the optical axis with small and smoothly varying magnitudes across the field. Referring to FIG. 15C., the map illustrates near-zero geometric distortion across the usable field of view according to some embodiments of the RC telescope system illustrated in FIG. 15A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.1314, the average distortion is approximately 0.0159, and the standard deviation is approximately 0.0145. FIG. 15C shows that, advantageously, the configuration of the RC telescope system achieves reduced geometric distortion across the usable field of view while maintaining image-space telecentricity.

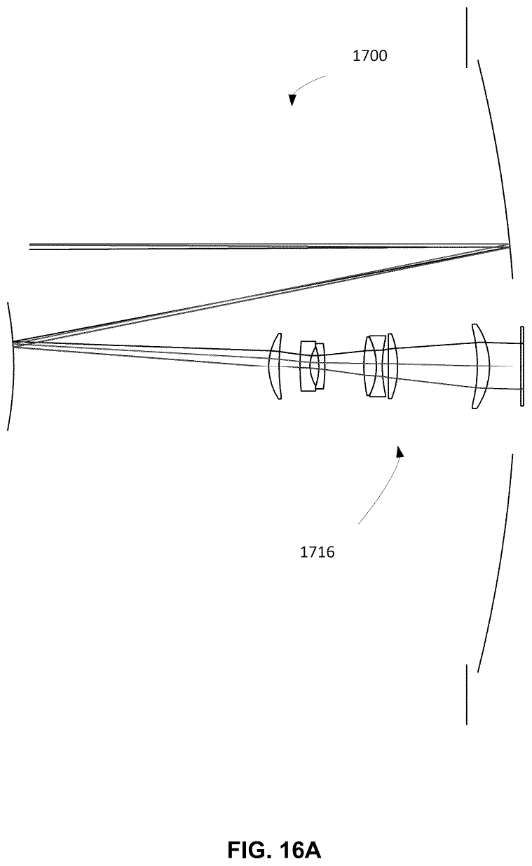

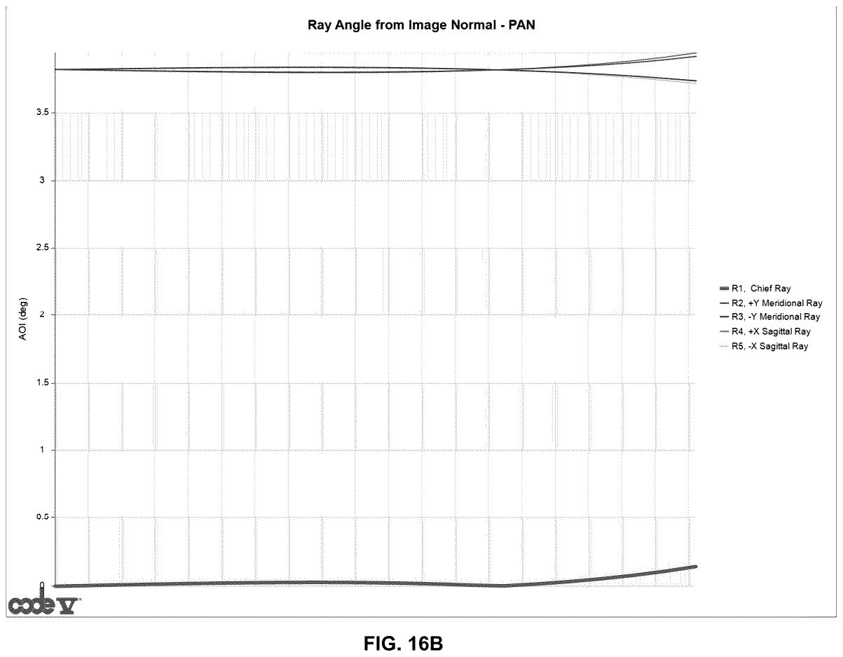

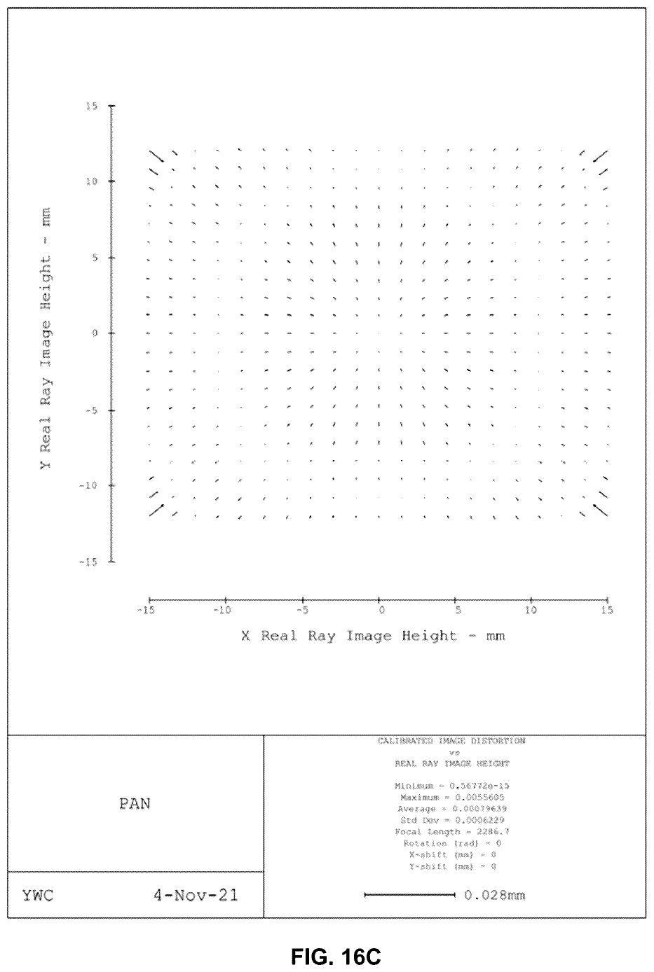

FIG. 16A is a schematic illustration showing another embodiment of a Ritchey-Chrétien telescope system 1700 that may be used for space-based imaging. FIG. 16B illustrates an example chief-ray angle versus field position at image planes according to the FIG. 16A embodiment. FIG. 16C illustrates an example field distortion map of the FIG. 16A embodiment.

Referring to FIG. 16A, a schematic of an embodiment of a RC telescope system 1700 is shown. In certain embodiments, the RC telescope system 1700 may have an EFL of about 2300 mm and a CLA of about 300 mm. Unless otherwise indicated, the embodiments illustrated in FIG. 15A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

FIG. 16A illustrates a very long focal length embodiment in which axial SPACING tolerances between the primary mirror and the secondary mirror are maintained by the metering structure. In certain embodiments, the corrector assembly 1716 may be positioned along the optical axis between the primary mirror and the secondary mirror. As shown in FIG. 16A, the lens elements of the corrector assembly 1716 may be axially spaced apart from one another with defined distances that are greater than in more compact configurations, thereby forming a longitudinally distributed arrangement between the mirrors. Image-space telecentricity may be achieved by adjusting optical parameters, e.g., surface curvature and axial spacing among the lens elements. The rays are controlled to converge through the corrector assembly 1716 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 16B, the chief-ray angle versus field position demonstrates the image-space telecentricity at the image plane according to some embodiments of the RC telescope system in FIG. 16A. As shown in FIG. 16B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, 1 degree, or 0.5 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 2300 mm and a CLA of about 300 mm.

FIG. 16B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 16B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 16C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 16C., the map illustrates near-zero geometric distortion across the usable field of view according to some embodiments of the RC telescope system illustrated in FIG. 16A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.0056, the average distortion is approximately 0.0008, and the standard deviation is approximately 0.00062. FIG. 16C shows that, advantageously, the configuration of the RC telescope system achieves reduced geometric distortion across the usable field of view while maintaining image-space telecentricity.

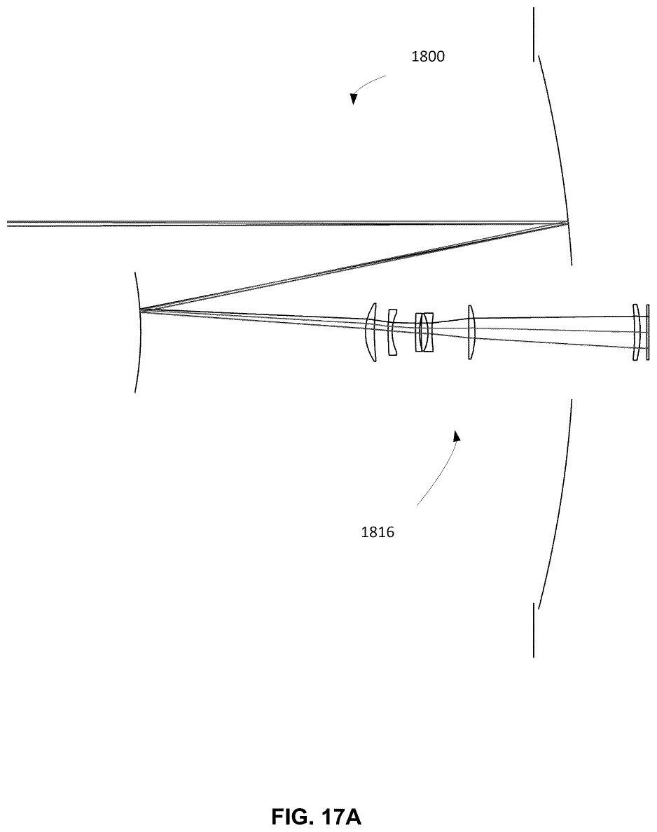

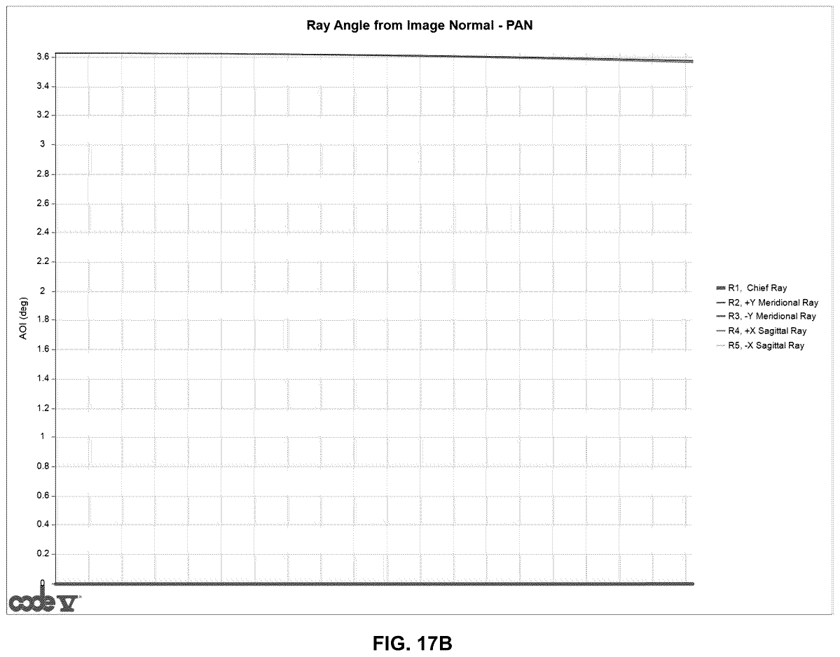

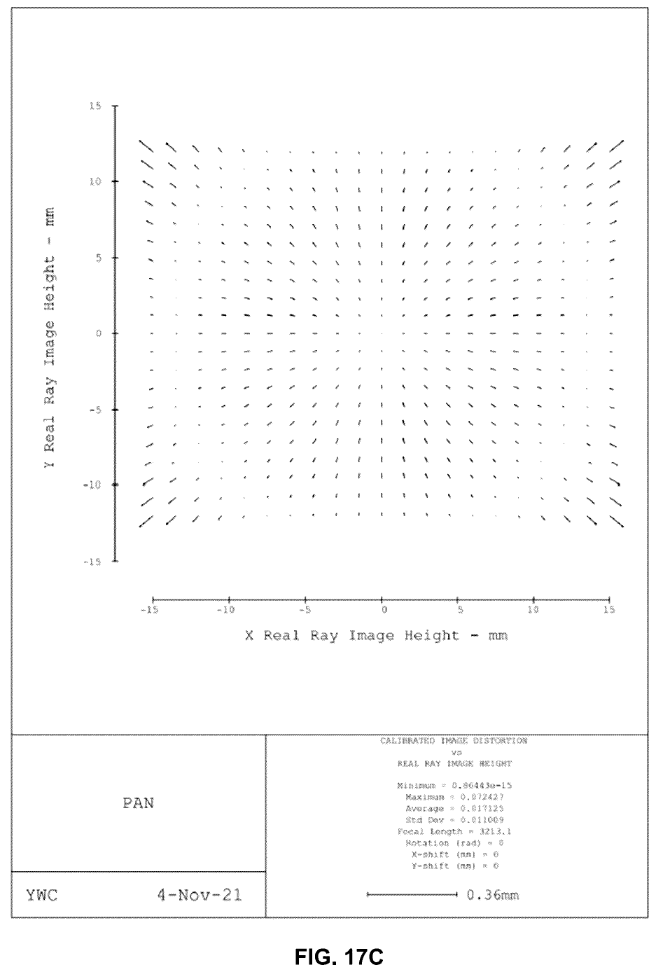

FIG. 17A is a schematic illustration showing another embodiment of a Ritchey-Chrétien telescope system 1800 that may be used for space-based imaging. FIG. 17B illustrates an example chief-ray angle versus field position at image planes according to the FIG. 17A embodiment. FIG. 17C illustrates an example field distortion map of the FIG. 17A embodiment.

Referring to FIG. 17A, a schematic of an embodiment of a RC telescope system 1800 is shown. In certain embodiments, the RC telescope system 1800 may have an EFL of about 3200 mm and a CLA of about 400 mm. Unless otherwise indicated, the embodiments illustrated in FIG. 15A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

FIG. 17A illustrates a wider aperture embodiment configured to maintain distortion below predetermined thresholds. In certain embodiments, the corrector assembly 1816 may be positioned along the optical axis between the secondary mirror and the image plane. A first subset of the lens elements of the corrector assembly may be positioned between the primary mirror, and a second subset of the lens elements may be positioned outside the outer diameter of the primary mirror. As shown in FIG. 17A, the lens elements of the corrector assembly 1816 may be axially spaced apart from one another with defined axial spacing, forming a distributed arrangement along the optical axis between the secondary mirror and the image plane. Image-space telecentricity may be achieved by adjusting optical parameters, e.g., surface curvature and axial spacing among the lens elements. The rays are controlled to converge through the corrector assembly 1816 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 17B, the chief-ray angle versus field position demonstrates the image-space telecentricity at the image plane according to some embodiments of the RC telescope system in FIG. 17A. As shown in FIG. 17B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, 1 degree, or 0.5 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 3200 mm and a CLA of about 400 mm.

FIG. 17B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 0.5 degree across at least 70%, 80%, or 90% of the active image height. As shown in FIG. 17B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 17C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 17C., the map illustrates near-zero geometric distortion across the usable field of view according to some embodiments of the RC telescope system illustrated in FIG. 17A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.0724, the average distortion is approximately 0.0171, and the standard deviation is approximately 0.0110. FIG. 17C shows that, advantageously, the configuration of the RC telescope system achieves reduced geometric distortion across the usable field of view while maintaining image-space telecentricity.

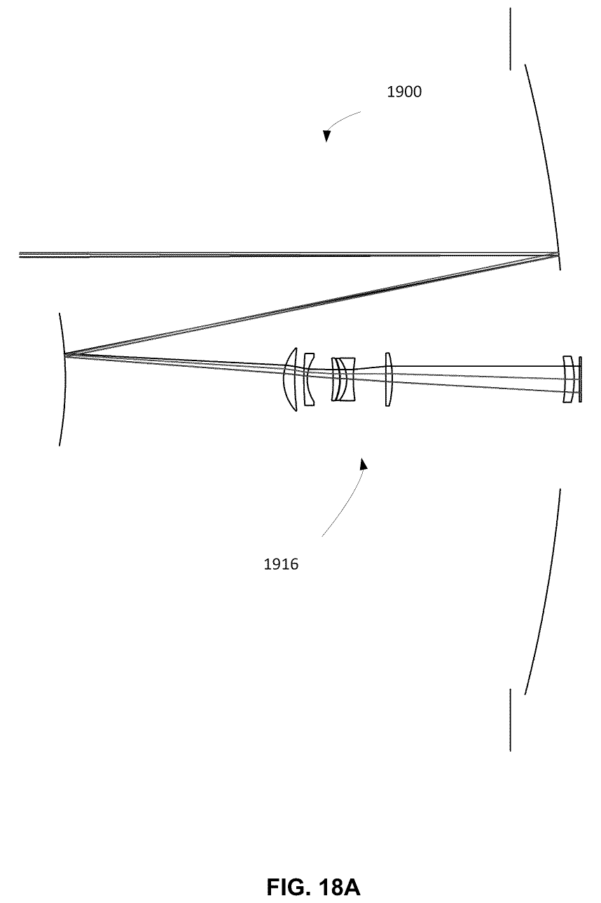

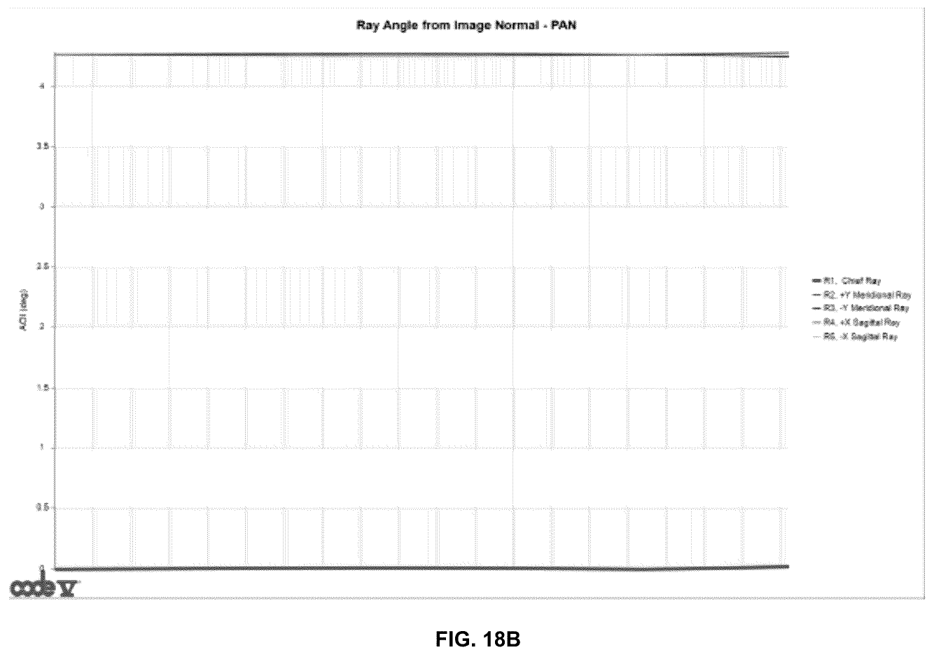

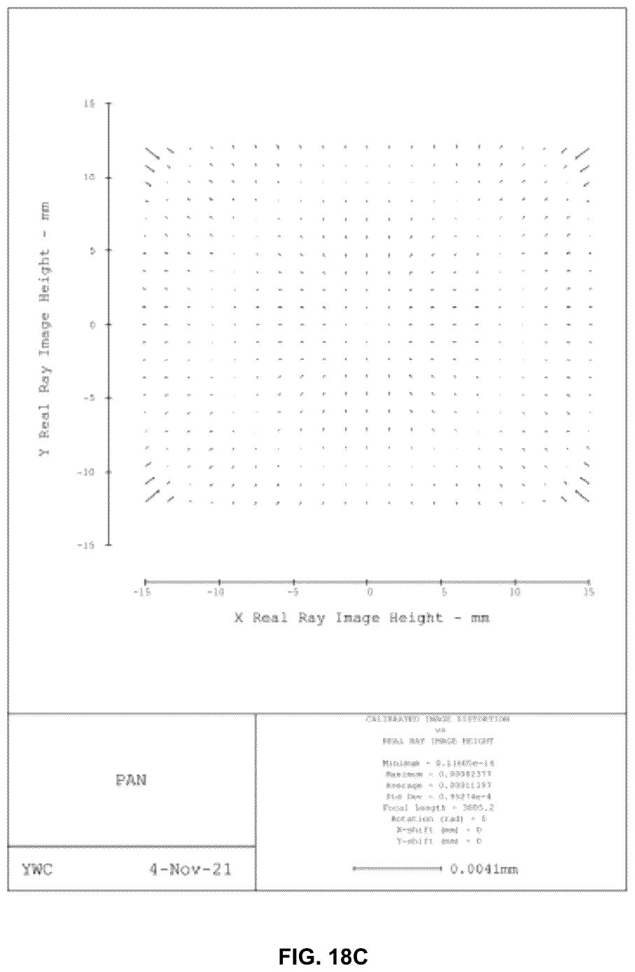

FIG. 18A is a schematic illustration showing another embodiment of a Ritchey-Chrétien telescope system 1900 that may be used for space-based imaging. FIG. 18B illustrates an example chief-ray angle versus field position at image planes according to the FIG. 18A embodiment. FIG. 18C illustrates an example field distortion map of the FIG. 18A embodiment.

Referring to FIG. 18A, a schematic of an embodiment of a RC telescope system 1900 is shown. In certain embodiments, the RC telescope system 1900 may have an EFL of about 3800 mm and a CLA of about 560 mm. Unless otherwise indicated, the embodiments illustrated in FIG. 18A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

In certain embodiments, the corrector assembly 1916 may be positioned along the optical axis between the primary mirror and the secondary mirror. At least one of the lens elements of the corrector assembly 1916 may be positioned closer to the primary mirror than the remaining lens elements. As shown in FIG. 18A, the corrector assembly 1916 may include 7 lens elements. the lens elements of the corrector assembly 1916 may be axially spaced apart from one another with defined axial spacing, forming a distributed arrangement along the optical axis between the primary mirror and the secondary mirror. Image-space telecentricity may be achieved by adjusting optical parameters, e.g., surface curvature and axial spacing among the lens elements. The rays are controlled to converge through the corrector assembly 1916 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 18B, the chief-ray angle versus field position demonstrates the image-space telecentricity at the image plane according to some embodiments of the RC telescope system in FIG. 18A. As shown in FIG. 18B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, 1 degree, or 0.5 degree. The CRA may be maintained below a specified value across, e.g., at least about 50%, at least about 60%, at least about 70%, at least about 80%, or at least about 90% of the usable field of view. In certain embodiments, the ray angle as a function of field position corresponds to an optical configuration having an EFL of about 3800 mm and a CLA of about 560 mm.

FIG. 18B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 0.5 degree across at least 70%, 80%, or 90% of the active image height. As shown in FIG. 18B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 18C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 18C., the map illustrates near-zero geometric distortion across the usable field of view according to some embodiments of the RC telescope system illustrated in FIG. 18A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.00082, the average distortion is approximately 0.000112, and the standard deviation is approximately 0.000095. FIG. 18C shows that, advantageously, the configuration of the RC telescope system achieves reduced geometric distortion across the usable field of view while maintaining image-space telecentricity.

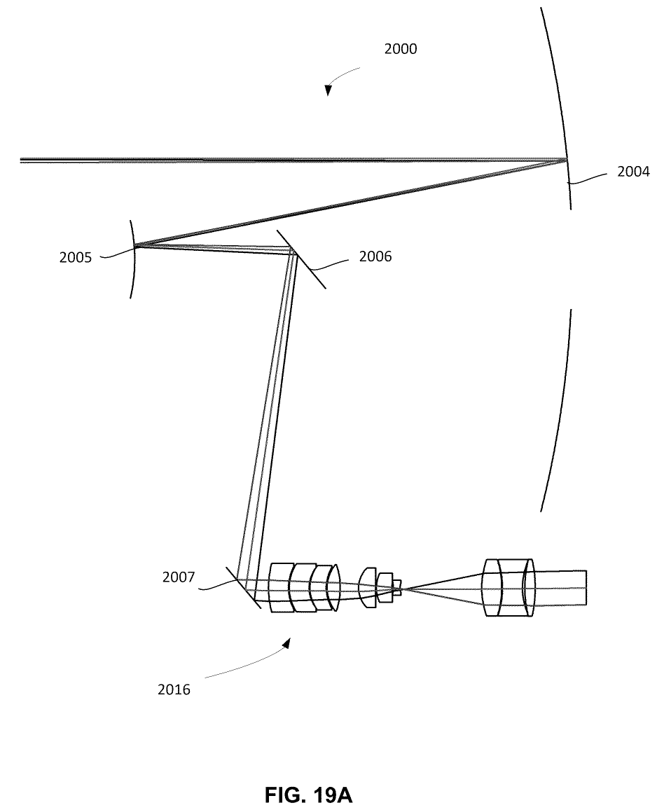

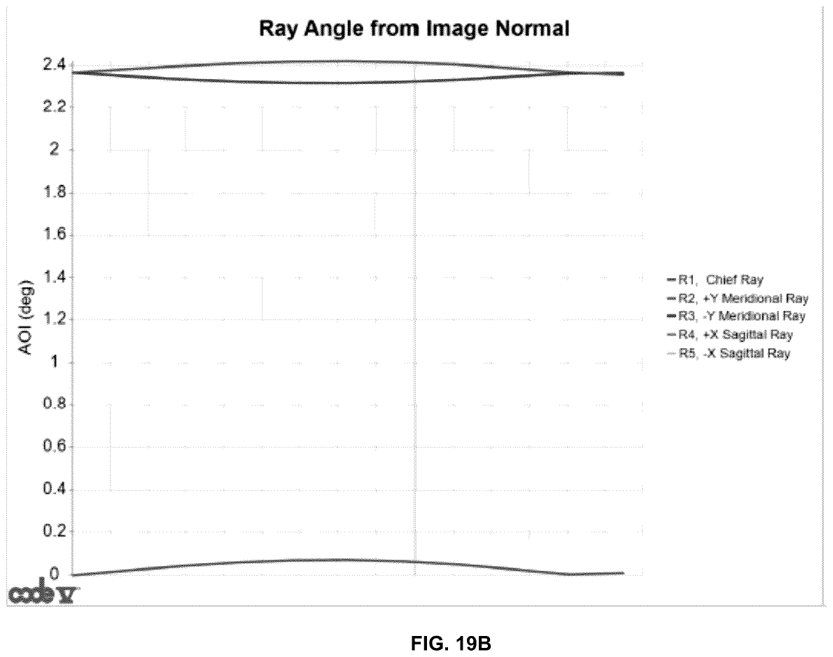

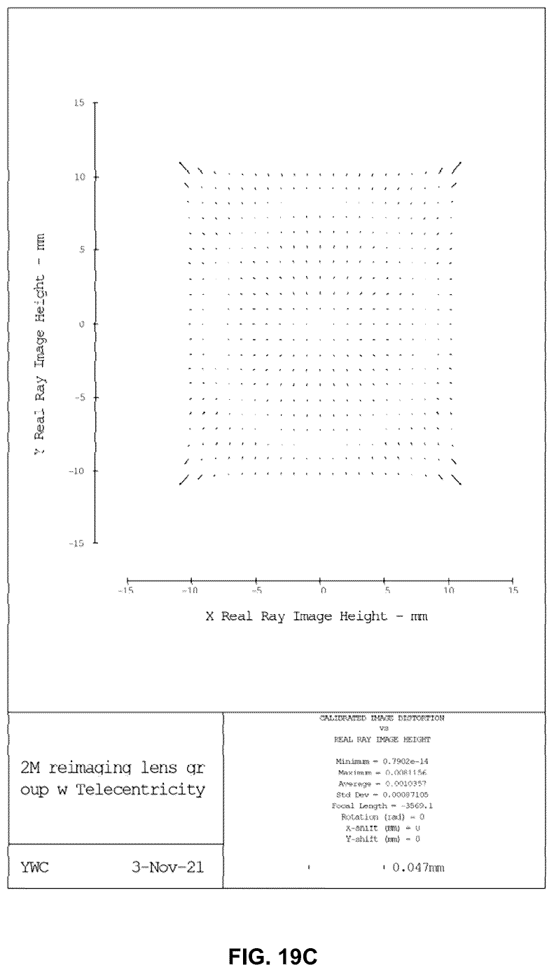

FIG. 19A is a schematic illustration showing another embodiment of a Ritchey-Chrétien telescope system 2000 that may be used for space-based imaging. FIG. 19B illustrates an example chief-ray angle versus field position at image planes according to the FIG. 19A embodiment. FIG. 19C illustrates an example field distortion map of the FIG. 19A embodiment.

Referring to FIG. 19A, a schematic of an embodiment of a RC telescope system 2000 is shown. Unless otherwise indicated, the embodiments illustrated in FIG. 19A may include substantially the same features, elements, and arrangements of the primary mirror, secondary mirror, corrector assembly, image plane, mirror distance, numbers of lens elements, and diameter of primary mirror as those described with respect to FIG. 1. A detailed description thereof is omitted for the sake of brevity.

As shown in FIG. 19A, the RC telescope system 2000 may include more than two mirrors. The system 2000 may include a concave tertiary mirror 2006 arranged behind the secondary mirror 2005. The tertiary mirror 2006 may have one of a parabolic surface, a non-parabolic conical surface, or an aspherical surface. The system 2000 may further include a concave quaternary mirror 2007 positioned along the folded optical path between the tertiary mirror 2006 and the corrector assembly 2016 and configured to redirect the light toward the corrector assembly 2016. The quaternary mirror 2007 may have one of a planar surface, a spherical surface, a parabolic surface, a non-parabolic conical surface, or an aspherical surface. The system 2000 may optionally include one or more additional mirrors configured to redirect all or a portion of the light rays to alter the optical path. The corrector assembly 2016 may include at least 6 lens elements, for example, at least 6, 7, 8, 9, 10, 11, or 12, 13, 14, 15, 16, 17, 18, 19, or 20, or more lens elements. In certain embodiments, at least one lens element of the corrector assembly 2016 may be positioned off the primary optical axis. The lens elements may be positioned at least partially outside an inner diameter of the primary mirror. In the illustrated embodiment, the corrector assembly 2016 may be positioned along a folded optical path defined by the tertiary mirror 2006 and the quaternary mirror 2007.

Image-space telecentricity may be achieved by adjusting optical parameters, e.g., surface curvature and axial spacing among the lens elements. The rays are controlled to converge through the corrector assembly 2016 and direct to the image plane to form the final image. The rays are parallel to the optical axis at the image plane, thereby demonstrating telecentricity. In some embodiments, the mirror distance may have a variety of numbers as described with respect to FIG. 1. This configuration can maintain imaging performance, e.g., controlled distortion and telecentric performance, allowing the compact structure.

Referring to FIG. 19B, the chief-ray angle versus field position demonstrates the image-space telecentricity at the image plane according to some embodiments of the RC telescope system in FIG. 19A. As shown in FIG. 19B, the rays are substantially parallel to the optical axis at the image plane, which demonstrates telecentricity. In various embodiments, the CRA at the image plane may be equal or less than about 5 degrees, 3 degrees, 2 degrees, 1.5 degrees, 1 degree, or 0.5 degree. The CRA may be maintained below a specified value across, e.g., at least about 50%, at least about 60%, at least about 70%, at least about 80%, or at least about 90% of the usable field of view.

FIG. 19B illustrates the curves corresponding to different rays, e.g., the chief ray, +Y meridional ray, −Y meridional ray, +X sagittal ray, and −X sagittal ray. In certain embodiments, the chief-ray angle can remain substantially near zero degrees across the central portion of the usable field, demonstrating image-space telecentricity. In certain embodiments, the chief-ray angle may remain below approximately 1 degree across at least 70%, 80%, or 90% of the active image height. As shown in FIG. 19B, the ray angles, e.g., meridional and sagittal ray angles, can exhibit controlled and substantially symmetric variation with increasing field position. These embodiments demonstrate the achieved telecentricity without reliance on an external aperture stop positioned at a real exit pupil.

FIG. 19C illustrates a calibrated geometric distortion field map plotted as vector displacement versus real ray image height across a field extending approximately ±15 mm in both X and Y directions. The distortion vectors may be substantially radially symmetric about the optical axis with small and smoothly varying magnitudes across the field. Referring to FIG. 19C, the map illustrates near-zero geometric distortion across the usable field of view according to some embodiments of the RC telescope system illustrated in FIG. 19A. In certain embodiments, distortion may be maintained below approximately 5%, 4%, 3%, 2%, 1%, 0.5%, or 0.3% across the usable field of view. The map indicates numerical values in which the minimum distortion is approximately zero, the maximum distortion is approximately 0.0081, the average distortion is approximately 0.0010, and the standard deviation is approximately 0.00087. FIG. 19C shows that, advantageously, the configuration of the RC telescope system achieves reduced geometric distortion across the usable field of view while maintaining image-space telecentricity.

### Time-Delay Integration (TDI)

The optical system, e.g., RC telescope system or Cassegrain telescope system, may further include one or more sensors 119 operatively coupled to the telescope and configured to receive light at the image plane and generate image signals representative of the received light. The sensors may be disposed at or proximate to the image plane. In some embodiments, the sensors may be or may include TDI sensors.

Time-delay integration in line-scanning detectors accumulates charge corresponding to a moving ground target over multiple sequential detector stages. As the image of the ground scene translates across the focal plane due to relative motion between the platform and the Earth, charge packets are synchronously shifted through successive pixel rows. The accumulated signal improves signal-to-noise ratio (SNR) relative to a single-stage integration of equivalent exposure duration.

Effective TDI operation benefits from substantially uniform projection geometry across the focal plane. Variations in chief-ray angle, magnification, or geometric distortion may introduce image smear between integration stages, thereby reducing modulation transfer function (MTF) and effective resolution.

As described above, the optical system can be configured to provide image-space telecentricity at the image plane. The chief rays at the image plane can be substantially parallel to the optical axis across at least a portion of the usable field of view. Because each row of pixels in a telecentric system views the ground under substantially identical angles, synchronization of charge transfer in TDI operation is simplified. Distortion-induced smear may thereby be reduced, resulting in sharper imagery and improved effective resolution for a given integration time.

In some embodiments, the CRA at the image plane may be maintained below a specified value, e.g., less than or equal to about 5 degrees, 3 degrees, 2 degrees, 1.5 degrees, or 1 degree, across at least about 50%, 60%, 70%, 80%, or 90% of the usable field of view. Maintaining a low and uniform CRA across the field may improve inter-stage alignment in multi-stage TDI detectors.

In some embodiments, the substantially constant angular relationship between object space and image space simplifies motion compensation algorithms. A stable and predictable mapping between ground motion and detector readout facilitates synchronization across multiple TDI integration stages. Uniform or substantially uniform magnification across the field may further reduce stage-to-stage misregistration. In some embodiments, geometric distortion may be maintained below approximately 5%, 4%, 3%, 2%, 1%, 0.5%, 0.3%, or 0.1% across the usable field of view, depending on system requirements. In certain embodiments, MTF degradation resulting from axial displacement of the secondary mirror may remain below approximately 10% at Nyquist frequency for secondary mirror displacements of ±1 μm, ±3 μm, ±5 μm, ±10 μm, ±15 μm, ±20 μm, ±25 μm, or ±30 μm. Such robustness may be advantageous in space-based platforms subject to thermal or mechanical perturbations. In some embodiments, the combination of near-zero distortion and low chief-ray angle performance enables the optical system to operate effectively with TDI sensors. Advantageously, the resulting configuration may provide improved SNR, reduced smear, and enhanced effective spatial resolution while maintaining compact system geometry.

### Satellite

In some embodiments, the optical systems described herein may be incorporated into a satellite. The satellite may include any of the RC telescope systems and Cassegrain telescope systems described above and a spacecraft bus operatively coupled to the optical system.

### ADDITIOANL EMBODIMENTS

1. A telecentric Ritchey-Chrétien telescope for Earth observation, configured for operation at altitudes below 500 km, the telescope comprising:
   a hyperbolic primary mirror having a central aperture;
   a hyperbolic secondary mirror aligned with the primary mirror so as to reflect an incoming beam back through the central aperture;
   a telecentric corrector assembly having fewer than six lens elements, each lens formed from one of three distinct optical materials, the corrector assembly being arranged to produce an image-space telecentric output; and
   a focal plane disposed where the chief rays across a desired field of view are substantially perpendicular to the plane, enabling a ground sample distance better than 10 meters at the altitude.
2. A method for high-resolution, wide-field imaging of Earth's surface below km altitude using a telecentric Ritchey-Chrétien telescope, the method comprising:
   providing a folded optical train wherein a hyperbolic primary mirror and a hyperbolic secondary mirror define a Ritchey-Chrétien configuration;
   placing a telecentric corrector assembly having fewer than six lens elements near the focal plane, the lens elements drawn from three distinct optical materials;
   capturing images so that chief rays across a wide field strike the focal plane at near-normal incidence, thus minimizing perspective distortion; and
   achieving a ground sample distance better than 10 meters while maintaining a broad swath of coverage.
3. A satellite payload for multi-spectral or hyperspectral Earth observation at altitudes below 500 km, the payload comprising:
   a spacecraft bus;
   a Ritchey-Chrétien telescope including a hyperbolic primary mirror and a hyperbolic secondary mirror;
   a telecentric corrector assembly having fewer than six lens elements, each lens formed from one of three different optical materials, configured to produce a telecentric image space; and
   at least one detector array positioned at the telecentric focal plane, such that multi-spectral or hyperspectral channels are observed under substantially identical geometric conditions.
4. A time-delay integration (TDI) imaging system, comprising:
   a hyperbolic primary mirror and a hyperbolic secondary mirror arranged in a Ritchey-Chrétien format;
   a telecentric corrector disposed so that chief rays over the width of a pushbroom or line-scanning detector are near-parallel to the optical axis;
   a line-scanning TDI detector configured to accumulate charge over multiple integrations;
   wherein the telecentric condition mitigates distortion and preserves uniform pixel footprints, reducing smear or parallax during TDI accumulation.
5. The telecentric Ritchey-Chrétien telescope of example embodiment 1, wherein the three distinct optical materials comprise at least one of:
   BK7,
   Fused Silica, and
   Calcium Fluoride (CaF_2).
6. The telescope of example embodiment 1, wherein the telecentric corrector assembly is configured with at least one doublet formed from two of the three distinct materials to balance dispersion and achieve broadband performance.
7. The telescope of example embodiment 1, further comprising a low-expansion metering structure that secures the primary mirror, secondary mirror, and telecentric corrector assembly in a stable alignment through orbital temperature cycles.
8. The telescope of example embodiment 1, wherein the focal plane comprises a 2D imaging array or a line-scanning pushbroom sensor adapted for multi-spectral or hyperspectral data acquisition.
9. The telescope of example embodiment 1, wherein the maximum count of lens elements in the telecentric corrector is five, each lens having an anti-reflection coating optimized for a specified spectral range.
10. The telescope of example embodiment 1, further comprising one or more baffles arranged to reduce stray light between the primary mirror, the secondary mirror, and the telecentric corrector assembly.
11. The method of example embodiment 2, wherein the images are used for multi-spectral or hyperspectral analysis, each spectral band experiencing a near-identical geometric projection at the focal plane.
12. The method of example embodiment 2, further comprising actively adjusting lens spacing or tilt in-orbit to maintain telecentricity amid thermal shifts or mechanical stresses.
13. The method of example embodiment 2, wherein said capturing images includes operating a time-delay integration (TDI) detector, the telecentric geometry ensuring minimal motion-induced smear for sub-10-meter GSD imaging.
14. The satellite payload of example embodiment 3, wherein the fewer than six lens elements collectively correct residual astigmatism, field curvature, and chromatic aberration across at least two spectral bands.
15. The satellite payload of example embodiment 3, wherein the spacecraft bus includes thermal control systems (heaters, radiators, insulation) designed to preserve alignment of the telecentric corrector assembly within predetermined tolerances over day-night orbital cycles.
16. The satellite payload of example embodiment 3, further comprising a multi-spectral beam-splitter or prism assembly positioned such that each waveband is received at the telecentric focal plane, ensuring consistent band-to-band pixel footprints.
17. The TDI imaging system of example embodiment 4, wherein the telecentric corrector assembly includes at least one aspheric lens to optimize off-axis performance and minimize distortion across a detector line width of at least 10,000 pixels. 18. The TDI imaging system of example embodiment 4, wherein the line-scanning TDI detector is configured to achieve a signal-to-noise ratio improvement of at least 2× compared to single-pass scanning, owing to uniform chief-ray geometry.
19. The TDI imaging system of example embodiment 4, further comprising motion compensation electronics that synchronize the TDI integration rate with the satellite's ground velocity, enhanced by telecentric uniformity across the scan line.
20. The TDI imaging system of example embodiment 4, wherein the aperture of the hyperbolic primary mirror and the focal length are selected to achieve a sub-10-meter GSD while maintaining a swath width in excess of 20 km at orbital altitudes below 500 km.
21. The telecentric Ritchey-Chrétien telescope of example embodiment 1, wherein the corrector lenses are mounted in a thermally compensated lens cell, maintaining optimal inter-element spacing despite temperature variations.
22. The method of example embodiment 2, further comprising a step of data processing wherein orthorectification and mosaicking are simplified due to telecentric imaging, providing near-real-time map products for disaster management or agricultural monitoring.
23. The satellite payload of example embodiment 3, wherein the multi-spectral or hyperspectral detector array covers at least four distinct wavebands, each band registered within a sub-pixel tolerance, facilitated by the telecentric design.
24. The telescope of example embodiment 1, wherein the system is configured to be deployed in a constellation of satellites, each carrying a nearly identical telecentric RC assembly to enable high revisit rates or global coverage.
25. The telescope of example embodiment 1, wherein the structure supporting the primary mirror, the secondary mirror, and the corrector assembly is formed from carbon fiber-reinforced polymer (CFRP) or silicon carbide to achieve low mass and low thermal expansion.
26. A method for operating a Ritchey-Chrétien telescope system, the method comprising: receiving light with an RC telescope system including a primary mirror having a diameter and a secondary mirror aligned with the primary mirror along an optical axis extending from a vertex of the primary mirror to a vertex of the secondary mirror, a distance between the primary mirror and the secondary mirror along the optical axis being a mirror distance; directing the received light through a corrector assembly comprising a plurality of lens elements to form a corrected image; and maintaining the mirror distance at less than or equal to 1.5 times the diameter of the primary mirror while forming the corrected image.
26.The method of example embodiment 26, wherein maintaining the mirror distance comprises maintaining the mirror distance at less than or equal to 1.5 times the diameter of the primary mirror while the RC telescope system is receiving the electromagnetic radiation.
27.The method of example embodiment 26, wherein operating the RC telescope system comprises operating the RC telescope system such that a telecentricity of the RC telescope system is maintained substantially constant.
28.The method of example embodiment 26, further comprising receiving the light transmitted through the corrector assembly at an image plane after the light is reflected from the primary mirror and reflected from the secondary mirror.
29.The method of example embodiment 28, wherein operating the RC telescope system comprises directing the light through the corrector assembly such that chief rays are substantially parallel to the optical axis at the image plane.
30.The method of example embodiment 26, wherein the corrector assembly comprises at least six lens elements.
31.The method of example embodiment 26, wherein operating the RC telescope system comprises transmitting the light through the plurality of lens elements positioned along the optical axis between the primary mirror and the secondary mirror.
32.The method of example embodiment 26, wherein operating the RC telescope system comprises transmitting the light through at least one lens element of the corrector assembly that is not positioned along the optical axis.
33.The method of example embodiment 32, wherein the RC telescope system further comprises a tertiary mirror, and wherein operating the RC telescope system comprises reflecting the light from the tertiary mirror.
34.The method of example embodiment 33, wherein operating the RC telescope system comprises reflecting the light from the secondary mirror toward the tertiary mirror along a secondary optical axis extending from a vertex of the secondary mirror to a vertex of the tertiary mirror.
35.The method of example embodiment 26, wherein operating the RC telescope system comprises transmitting the light through the plurality of lens elements positioned outside an outer diameter of the primary mirror.
36.The method of example embodiment 35, wherein operating the RC telescope system comprises transmitting the light through all of the plurality of lens elements aligned along the optical axis.
37.The method of example embodiment 36, wherein the corrector assembly comprises a first end and a second end opposing each other, and wherein maintaining the mirror distance comprises maintaining the mirror distance greater than a distance between the vertex of the primary mirror and the first end of the corrector assembly, the first end being closer to the primary mirror than the second end.
38.The method of example embodiment 26, wherein operating the RC telescope system comprises transmitting the light through a first subset of lens elements positioned between the primary mirror and the secondary mirror and through a second subset of lens elements positioned outside an outer diameter of the primary mirror.
39.The method of example embodiment 38, wherein operating the RC telescope system comprises transmitting the light through the first subset and the second subset of lens elements aligned along the optical axis.
40.The method of example embodiment 26, further comprising adjusting a position of the corrector assembly with respect to the primary mirror and the secondary mirror to adjust a focal length of the primary mirror.
41.The method of example embodiment 28, wherein maintaining the telecentricity comprises selecting or adjusting radii of curvature of the plurality of lens elements of the corrector assembly.
42.The method of example embodiment 28, wherein maintaining the telecentricity comprises selecting or adjusting axial spacing between the plurality of lens elements of the corrector assembly.
43.The method of example embodiment 29, further comprising receiving, by one or more sensors operatively coupled to the RC telescope system, the light at the image plane and generating image signals representative of the received light.
44.The method of example embodiment 26, further comprising operating the RC telescope system onboard a satellite to generate the image signals.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment may be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the inventions are susceptible to various modifications, and alternative forms, specific examples thereof have been shown in the drawings and are herein described in detail. It should be understood, however, that the inventions are not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, “up to about,” and “substantially” as used herein include the recited numbers, and also represent an amount or characteristic close to the stated amount or characteristic that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount or characteristic. Features of embodiments disclosed herein preceded by a term such as “approximately”, “about”, and “substantially” as used herein represent the feature with some variability that still performs a desired function or achieves a desired result for that feature.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced embodiment recitation is intended, such an intent will be explicitly recited in the embodiment, and in the absence of such recitation no such intent is present. For example, as an aid to understanding, the disclosure may contain usage of the introductory phrases “at least one” and “one or more” to introduce embodiment recitations. However, the use of such phrases should not be construed to imply that the introduction of an embodiment recitation by the indefinite articles “a” or “an” limits any particular embodiment containing such introduced embodiment recitation to embodiments containing only one such recitation, even when the same embodiment includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, embodiments, or drawings, should be understood to contemplate the possibilities of including one of the terms, either of the terms, or both terms. For example, the phrase “A or B” will be understood to include the possibilities of “A” or “B” or “A and B.”

Although the present subject matter has been described herein in terms of certain embodiments, and certain exemplary methods, it is to be understood that the scope of the subject matter is not to be limited thereby. Instead, the Applicant intends that variations on the methods and materials disclosed herein which are apparent to those of skill in the art will fall within the scope of the disclosed subject matter.

What is claimed is:

1. A Ritchey-Chrétien (RC) telescope system comprising:
an RC telescope comprising:
a primary mirror having a diameter;
a secondary mirror aligned with the primary mirror along an optical axis extending from a vertex of the primary mirror to a vertex of the secondary mirror, wherein a distance between the primary mirror and the secondary mirror along the optical axis is defined as a mirror distance; and
a corrector assembly comprising a plurality of lens elements, the corrector assembly being positioned with respect to the primary mirror and the secondary mirror such that the mirror distance is maintained at less than or equal to 1.5 times the diameter of the primary mirror.

2. The Ritchey-Chrétien telescope system of claim 1, wherein the corrector assembly is positioned with respect to the primary mirror and the secondary mirror such that the mirror distance is maintained at less than or equal to 1.2 times the diameter of the primary mirror.

3. The Ritchey-Chrétien telescope system of claim 1, wherein the corrector assembly is positioned such that a telecentricity of the Ritchey-Chrétien telescope system maintains substantially constant.

4. The Ritchey-Chrétien telescope system of claim 1, further comprising an image plane positioned to receive light transmitted through the corrector assembly after being reflected from the primary mirror and reflected from the secondary mirror.

5. The Ritchey-Chrétien telescope system of claim 4, wherein the plurality of lens elements of the corrector assembly are arranged such that chief rays are substantially parallel to the optical axis at the image plane.

6. The Ritchey-Chrétien telescope system of claim 1, wherein the corrector assembly comprises at least six lens elements.

7. The Ritchey-Chrétien telescope system of claim 1, wherein all of the plurality of lens elements of the corrector assembly are positioned along the optical axis between the primary mirror and the secondary mirror.

8. The Ritchey-Chrétien telescope system of claim 1, wherein at least one of the plurality of lens elements of the corrector assembly is not positioned along the optical axis.

9. The Ritchey-Chrétien telescope system of claim 8, further comprising a tertiary mirror.

10. The Ritchey-Chrétien telescope system of claim 9, wherein the tertiary mirror is aligned with the secondary mirror along a secondary optical axis extending from the vertex of the secondary mirror to a vertex of the tertiary mirror.

11. The Ritchey-Chrétien telescope system of claim 1, wherein all of the lens elements of the corrector assembly are positioned outside an outer diameter of the primary mirror.

12. The Ritchey-Chrétien telescope system of claim 11, wherein all of the lens elements are aligned along the optical axis.

13. The Ritchey-Chrétien telescope system of claim 12, wherein the corrector assembly comprises a first end and a second end opposing each other, and wherein the mirror distance is greater than a distance between the vertex of the primary mirror and the first end of the corrector assembly, and wherein the first end is closer to the primary mirror than the second end.

14. The Ritchey-Chrétien telescope system of claim 1, wherein a first subset of the lens elements of the corrector assembly is positioned between the primary mirror, and a second subset of the lens elements is positioned outside an outer diameter of the primary mirror.

15. The Ritchey-Chrétien telescope system of claim 14, wherein the first subset and the second subset are aligned along the optical axis.

16. The Ritchey-Chrétien telescope system of claim 1, wherein the primary mirror has a focal length adjustable according to a position of the corrector assembly with respect to the primary mirror and the secondary mirror.

17. The Ritchey-Chrétien telescope system of claim 3, wherein the telecentricity is maintained by adjusting radii of curvature of the plurality of lens elements of the corrector assembly.

18. The Ritchey-Chrétien telescope system of claim 3, wherein the telecentricity is maintained by adjusting axial spacing between the plurality of lens elements of the corrector assembly.

19. The Ritchey-Chrétien telescope system of claim 4, further comprising one or more sensors operatively coupled to the RC telescope and configured to receive light at the image plane and generate image signals representative of the received light.

20. A satellite comprising the Ritchey-Chrétien telescope system of claim 19.
